(19) United States
(12) Patent Application Publication
(10) Pub. No.: US 2021/0223738 A1
(43) Pub. Date: Jul. 22, 2021

(54) DISPLAY DEVICE AND METHOD FOR OPTIMIZING THE IMAGE QUALITY

(71) Applicant: SEEREAL TECHNOLOGIES S.A., Munsbach (LU)

(72) Inventor: Gerald FUTTERER, Dresden (DE)

(21) Appl. No.: 16/066,803

(22) PCT Filed: Dec. 23, 2016
(86) PCT No.: PCT/EP2016/082571

§ 371 Date: Jun. 28, 2018

(30) Foreign Application Priority Data
Dec. 28, 2015 (DE) 10 2015 122 851.3

(51) Int. Cl. G03H 1/26

(52) U.S. Cl. CPC G03H 1/268; G03H 2223/15; G03H 2223/20; G03H 2001/262; G03H 2222/34; G03H 2222/20; G03H 2223/22

(57) ABSTRACT

The invention relates to a display device for holographic reconstruction of two-dimensional and/or three-dimensional objects. The objects include a plurality of object points. The display device comprises an illumination unit, a spatial light modulator device and a separator. The illumination device emits sufficiently coherent light. Sub-holograms of object points to be displayed are encoded in pixels of the spatial light modulator device. The separator is provided for separating adjacent point spread functions in an eye of an observer generated by the sub-holograms of adjacent object points such that the adjacent point spread functions are mutually incoherent.

The present invention refers to a display device and a method for optimizing and increasing the image quality of a reconstructed scene with which retinal inter object point crosstalk can be suppressed.

The present display device is adapted for displaying two-dimensional (2D) and/or three-dimensional (3D) images. It shall be understood that two-dimensional images or three-dimensional images also include two-dimensional or three-dimensional contents or movies.

The field of application of the present invention includes preferably display devices for the three-dimensional presentation of holographic images.

In a commercially available display device for the presentation of two-dimensional images or movies/videos, it is necessary to realize a bright and homogeneous illumination of the entire surface at high resolution. A spatial light modulator device which serves as display panel is required to emit the light in a large angular range. The information to be presented is written into the spatial light modulator device of the display device. The light which is emitted by an illumination unit comprising a light source unit is modulated with the information that is written into the spatial light modulator device, where the spatial light modulator device often at the same time serves as screen or display panel. It is therefore necessary to strictly ensure parallel incidence of the light beams onto the spatial light modulator device and to achieve a high refresh rate of the spatial light modulator device. To achieve a high quality of the three-dimensional presentation of the information written into the spatial light modulator device, at least a defined collimation of the wave fronts that are coupled out of the illumination unit is necessary in addition to a homogeneous illumination of the entire surface of the spatial light modulator device. This is of high importance for holographic presentations in the form of a reconstruction that is to be generated. The holographic information, which can for example be an object that is composed of object points of a three-dimensional scene, is encoded in the form of amplitude and phase values in the pixels of the spatial light modulator device. The encoded object points are reconstructed by the wave field that is emitted by the spatial light modulator device.

A complex hologram value which serves to modulate both the phase and the amplitude of a wave front cannot be displayed satisfactorily directly in a single pixel of a conventional spatial light modulator device. The modulation of only one value per pixel, i.e. a phase-only modulation or an amplitude-only modulation, however only results in an insufficient holographic reconstruction of a preferably moving three-dimensional scene. A direct and thus optimal—in the sense of generalized parameters—representation of the complex hologram values can only be achieved by a complex valued modulation preferably at the same plane and at the same time in the spatial light modulator device.

However, the holographic reconstruction of preferably three dimensional objects consisting of individual object points or object point clouds causes inter object point crosstalk at the retina of an eye of an observer looking at the reconstructed object, which reduces the image quality of the presentation by introducing graininess added to the designed retinal image. Here, it must be pointed out that the term of “retinal inter object point crosstalk” does not describe the same as the term of “speckle”. At first sight could this be the case but on closer inspection there is an essential difference.

Speckle is a real random three-dimensional (3D) interference effect. In other words, the speckle effect results in the interference of coherent wavefronts of the same frequency, which add together to obtain a resultant wavefront whose amplitude varies randomly. For instance, speckle can be generated by illuminating a rough surface with laser light. There are two kinds of speckle, the objective speckle and the subjective speckle. The objective speckle is defined as a 3D interference pattern generated in a 3D space, i.e. when coherent light scattered off a rough surface falls on another surface or plane. The subjective speckle is defined as the interference pattern recognized by an individual subject, i.e. when a rough surface illuminated with coherent light is imaged and then a speckle pattern is observed in an image plane. Imaging means is used. The term speckle is described e.g. in Goodman, J. W. (1976), “Some fundamental properties of speckle”, JOSA, 66(11), 1145-1150.

The term “retinal inter object point crosstalk” is due to the coherent superposition of adjacent point spread functions (PSF). Adjacent object points generated in space are transformed to adjacent point spread functions present at the retina of an eye of a user/observer looking at the object points. The interference pattern generated at the retina of the eye of the observer depends on the complex-valued distribution of adjacent point spread functions representing two adjacent 3D object points generated in space by using a sub-hologram encoding technique, as e.g. disclosed in WO 2004/044659 A1. For instance, even slight phase variations can cause a significant change in the intensity distribution obtained at the retina of the eye of the observer and thus can be detected by the observer. An example describing this superposition of adjacent point spread functions in dependence on the mutual coherence and the mutual phase difference can be found in section 4.1.1 of the document of G. Fütterer, “UV-Shearing Interferometrie zur Vermessung lithographischer “Phase Shift” Masken und VUV-Strukturierung”, Progress in modern optics, Vol. 4, IOIP, MPF, Universität Erlangen-Nürnberg, 2005, ISBN: 3-932392-61-2.

This effect of the retinal inter object point crosstalk can be considered analytically and retinal point spread functions can be tailored in order to achieve the designed intensity distribution of the 3D object point or the 3D object point cloud without visible graininess. An example, which describes how a target intensity profile can be generated by tailoring the phase and intensity distribution of an object to be transferred onto the detector plane, which is for instance the retina, can be found in section 1.1.1 of the document of G. Fütterer, “UV-Shearing Interferometrie zur Vermessung lithographischer “Phase Shift” Masken und VUV-Strukturierung”, Progress in modern optics, Vol. 4, IOIP, MPF, Universität Erlangen-Nürnberg, 2005, ISBN: 3-932392-61-2.

The term speckle is still often rather used misleadingly to describe the effect which is due to retinal inter object point crosstalk. Speckle, which can be present in addition to the internal inter object point crosstalk, has to be clearly separated from the term retinal inter object point crosstalk. These two different terms describe two phenomena that are basically different in the sense of physics, as discussed above.

Known prior art documents describe one-dimensional (1D) encoding of holograms with color filter(s) and one RGB (red, green, blue) color filter group within approximately 1/20 degrees or color sequential 1D encoded RGB with vertical sub-holograms spanning a horizontal angular range of approximately 1/20 degrees to slightly less, which means still larger than 1/40 degrees angular range.

The document WO 2010/052331 A1 describes a display having color filters. A color filter with parallel vertical color stripes of the RGB base colors is assigned to image separating means. The color stripes repeat horizontally within the color filter in periodic fashion. A light modulator comprises a sequence of two holograms for each color interlaced into several pixel columns for a left eye and a right eye of an observer. The periods of the color filter and the hologram are arranged relative to one another with the same degree of expansion, where a color stripe and at least two pixel columns with holograms of the color of said color stripe are assigned to a separating element.

In a further document of the prior art a display device is disclosed, where orthogonal polarized polarization filters are provided in a spatial light modulator device for reducing crosstalk between neighboured pixels of the spatial light modulator device. However, it should be noted here that crosstalk should not be confused with the retinal inter object point crosstalk.

The document U.S. Pat. No. 8,441,703 B2 describes how to reconstruct spatially thinned object points which are placed at reasonable large distances to each other in order to show no overlap of the reconstructed point spread functions.

Thus, it is an object of the present invention to provide a display device and a method for optimizing and increasing the image quality of holographically reconstructed two-dimensional and/or three-dimensional objects. Especially, it is an object of the present invention to provide a display device and a method with which side lobes of the point spread function can be suppressed and retinal inter object point crosstalk can be reduced to achieve an increased or optimal image quality.

For this reason, the object according to the present invention is achieved by the features of claim 1.

A display device for holographic reconstruction of two-dimensional and/or three-dimensional objects includes a plurality of object points. The display device comprises an illumination unit, a spatial light modulator device and a separator. The illumination unit emits sufficiently coherent light which is incident on the spatial light modulator device. On the spatial light modulator device sub-holograms of object points to be displayed are encoded in pixels. The separator is provided for separating adjacent point spread functions in an eye of an observer generated by the sub-holograms of adjacent object points such that the adjacent point spread functions are mutual incoherent to each other to achieve an increased image quality.

The optimization of the designed intensity distribution on the retina can be achieved by mutual coherent object point optimization, which e.g. includes phase and amplitude adaption, and by adapting mutual incoherent subsets of object points in their intensity distributions in order to get the final design/target intensity distribution. This means that the sum intensity distribution of the point spread functions, which are mutual coherent, e.g. those, which are angularly spaced by 1/30 degrees, can be optimized by modifying the complex-valued distribution of the point spread functions in order to get the target intensity distribution, which represents the part of the ideal 3D content. The coherent sub-sets of object points, now optimized, are superimposed with other subsets, which are incoherent. Different sub-sets of object points are thus incoherent in relation to each other.

A complex-valued spatial light modulator device (SLM (C-SLM)) can be used. The spatial light modulator device might be e.g. a sandwich-type spatial light modulator device, which comprises a first spatial light modulator e.g. modulating the amplitude (A-SLM) and a second spatial light modulator e.g. modulating the phase (P-SLM) or vice versa.

Thus, the main idea according to the present invention is to use mutual incoherent subsets of reconstructed point spread functions that are equivalent to imaged three-dimensional (3D) object points, which are angularly placed within the angular resolution limit of a human eye, which is 1/60 degrees in the best case condition.

Further preferred embodiments and improvements of the present invention are defined in the dependent claims.

In a first preferred embodiment of the invention, the display device can be designed such that the object is divided into at least two object planes, where each object plane is divided into at least two, preferably three, vertical subsets and into at least two, preferably three, horizontal subsets, which are angularly displaced or shifted relative to each other.

It is provided to reconstruct spatially thinned object points. That means e.g. a reconstruction with an angular resolution of a grid of object points in a 1/30 degrees range, which is larger than the angular resolution of a human eye, which is 1/60 degrees. Additionally, it is provided to use two or preferably three vertical subsets and two or preferably three horizontal subsets, which are angularly displaced or shifted relative to each other in order to enhance the image quality, that suffers from the inter object point crosstalk, which takes place on the retina of the eye of the observer.

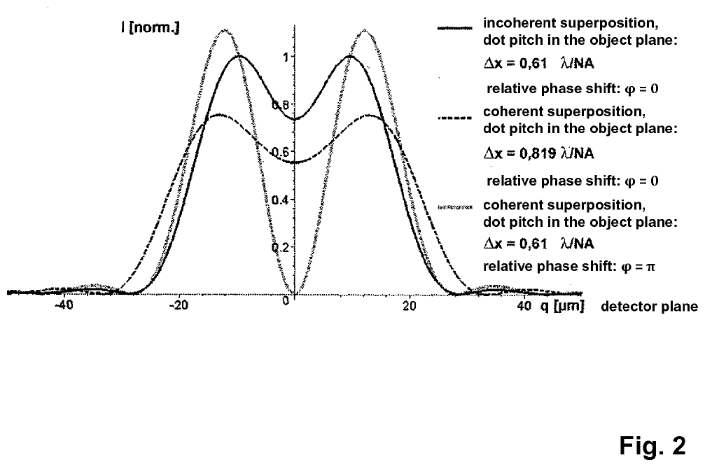

In FIG. 2 a diagram of side lobe interference of the point spread function is shown, which is the cause of the retinal inter object point crosstalk. In detail, FIG. 2 shows a superposition of adjacent point spread functions, which are described by using Airy-functions. The solid line shows the incoherent superposition at the resolution limit of an optical system, which is equivalent to 1/60 degrees angular spacing in the case of a human eye. The dashed line in FIG. 2 shows the coherent superposition of two point spread functions at the resolution limit. The relative phase difference between these two coherent point spread functions is zero. The percentage of the intensity decrease present in the centre between the two points is the same as in the incoherent case, which is approximately 75% of the peak intensities present at the left and at the right hand side of the centre of the intensity distribution. The dotted line shows the coherent superposition of two point spread functions at the resolution limit. The relative phase difference between these two coherent point spread functions is π (Pi). In this case an intensity value of zero is present between the two point spread functions. FIG. 2 shows that mutual coherence and mutual phase difference in the coherent case is important for the definition of the intensity distribution obtained on the retina of a human eye.

Adjacent retinal point spread functions, which represent three-dimensional object points, interfere with each other. One way to prevent or eliminate the interference of adjacent retinal point spread functions is to reduce or diminish side lobes of the generated diffraction pattern at all, which reduces the interference in the outer overlapping zones of the point spread function. However, in general the problem of retinal inter object point crosstalk is not solved by such an action. As a start the side lobes of the diffraction pattern are reduced to achieve the objects intensity distribution. If the coherent point spread functions move closer together and enlarge thus their overlap region, than the phase shift introduced defines the intensity distribution obtained. A relative phase shift of π (PI), as e.g. used for phase shifting masks, will generate a dark line between two adjacent object points and increase their recognized mutual distance to each other. This is shown in FIG. 2. In order to avoid that dark line between two adjacent object points it is preferable to use a mutual phase difference of π/2. It should be noted that this might serve as a start value for the optimization only. This also points out that a randomized phase distribution, which is present between the reconstructed object points, is not preferred. Values of adjacent phase differences close to T decrease the image quality present at the retina of an eye of an observer looking at the reconstructed objects.

According to the present invention, different approaches are provided to avoid any significant overlap of the retinal point spread functions PSFᵢⱼ to optimize the shape of the side lobes of the diffraction pattern, to reduce the side lobes and to optimize the relative phase differences of adjacent retinal point spread functions PSFᵢⱼ in order to enable a reasonable constant intensity distribution of the three-dimensional object, which can be seen from different positions within a virtual viewing window in an observer plane. If a randomized relative phase shift between adjacent object points is encoded, it is preferred to limit the phase range used to less than ±π/4. This can also be used for object points, which are placed at relative angular distances of e.g. 3× or 4× 1/60 degrees, which is referred to as HD (high definition) viewing.

In a further preferred embodiment of the present invention, it is provided that for one-dimensional encoded holograms or for two-dimensional encoded holograms in the spatial light modulator device, the separator can be designed as a color filter stripes arrangement, preferably a primary color filter stripes arrangement.

In the case of using one-dimensional (1D) encoding, which means e.g. vertical parallax only (VPO), mutual incoherent columns of the spatial light modulator device have to be used in order to generate the object points of the three-dimensional scene or of the three-dimensional object. This can be realized by using of a color filter stripes arrangement and by using of time-sequential color generation too.

Different colors can be displayed time-sequentially, e.g. if an LC (liquid crystal)-polarization grating is used for fine tracking. This also means that the present invention is not explicitly limited to the use of color filter stripes or color filters in general.

It is preferred to use more one-dimensional (1D) encoded stripes of the spatial light modulator device (SLM) than the number, which would be required for HD (high definition) resolution, which is equivalent to 1/60 degrees angular resolution or 60 object points per degree. This can be realized by using color filters. However, in some cases color filters would not be the right way to go. If color filters are used, at least two RGB (red, green, blue) filter stripe sets should be placed within a horizontal angular range of 1/60° deg. Object points can be reconstructed in an interaced way. Thus, adjacent object points reconstructed on the retina of an eye of an observer who observes a reconstructed scene consisting of a plurality of object points are incoherent to each other.

Preferably, each primary sub-hologram or initial pixel of the spatial light modulator device can be subdivided into at least two defined parts representing at least two subsets and generating at least two wave fields. In other words, a zone or region on the spatial light modulator device comprising a primary sub-hologram can be subdivided into at least two subsets or defined parts. A triplet (RGB) of color filter stripes can be assigned to each subset. More preferred is to increase the density of the color stripes assigned to a primary sub-hologram or a single initial pixel of the light modulator device e.g. to three times (3×) or four times (4×) of the original density of three color stripes per pixel. This means that each primary sub-hologram or each initial pixel is subdivided into three or four defined parts, so-called three or four subsets, where a triplet (RGB) of color filter stripes is assigned to each defined parts or subset.

In a further preferred embodiment of the present invention it can be provided that the color filter stripes arrangement is an absorptive-type dye based filter arrangement or a dielectric filter arrangement, which is structured assigned to the subset of the initial pixel or primary sub-hologram.

A color filter stripes arrangement or, in general, color filters can be used to reduce the frame rate mandatory for the SLM providing the complex-modulated wave field. It is possible to use preferably absorptive-type dye based filter arrays, which are structured aligned to the SLM pixels. Modern coating technology makes it possible to apply notch filters e.g. in a striped arrangement, too. This means that a color stripe might reflect two of the primary colors RGB (red, green, blue) while transmitting only one. This can be done with a coefficient of transmission greater than 0.9 while the two other not required wavelengths of this specific color stripe are reflected with a coefficient close to 1.

Advantageously, it can be provided that for a two-dimensional (2D) hologram to be encoded, the at least two defined parts of the primary sub-hologram or initial pixel form two halves, where the pixel is separated horizontally or vertically.

A spatial light modulator device (SLM) has pixel as modulation elements. The pixels can have a rectangular shape or a square shape or a round shape or a hexagonal shape or any other shape. Such a pixel of the SLM can be divided into at least two defined parts. These two defined parts of the pixel can form two halves. This means the pixel can be separated horizontally or vertically in order to form right and left parts/halves/subsets or upper and lower parts/halves/subsets. Essentially, two parts or subsets of the pixels are generated out of the SLM. The right subset of the SLM and the left subset or the lower subset of the SLM and the upper subset generate equivalent intensity distributions in the Fourier plane of the SLM. In other words, the intensity distribution in the Fourier plane of the amplitude distribution for the right/upper subset and the amplitude distribution for the left/lower subset are the same if a constant phase is used in the SLM. The values of the phase of both Fourier transformations are irrelevant for this explanation. Hence, it is used an incoherent superposition of the two subsets of the SLM as amplitude distributions.

Further, it can be provided advantageously that the separator is designed as an arrangement of patterned retarders, preferably for transforming light having a defined polarization state into two patterned subsets of the light.

The arrangement of patterned retarders is provided to transform an initial polarisation state, which might be e.g. a linear polarization state, into two patterned subsets. The two patterned subsets have an orthogonal polarization state. For example, the primary aperture of a pixel of the SLM, e.g. a square shaped pixel aperture or any other suitable shape, is divided into two parts. This means that it is doubled the initial pixel count of the SLM and thus also doubled the initial pixel density of the SLM. The two subsets of the initial pixel or primary sub-hologram are provided with defined patterned retarders. The first subset might be provided with a +π/4 patterned retarder and the second subset might be provided with a −π/4 patterned retarder. If the SLM containing these two subsets of each pixel is illuminated with linear polarized light, at the exit plane of the SLM two orthogonal polarized wave fields will be present, which are related to the two subsets of each pixel of the SLM carrying different patterned retarders. In other words, the arrangement of patterned retarders can be provided in a plane of the pixels and assigned to the pixels of the spatial light modulator device, where each defined part of the pixel or each subset of the pixel is provided with a defined patterned retarder of the arrangement of patterned retarders. The at least two defined parts of the pixel have different patterned retarders providing orthogonal polarization. Advantageously, the polarization orientations of adjacent patterned retarders, seen only in the horizontal direction or only in the vertical direction, are orthogonal to each other.

In a further embodiment of the present invention it can be provided that the arrangement of patterned retarders is designed as an arrangement of patterned polarization filters assigned to the at least two defined parts of the pixels. This allows the transmission of a horizontally orientated electrical field for the one subset of the pixel and the transmission of a vertically orientated electrical field for the other subset of the pixel. The arrangement of patterned polarization filters provides thus a striped pattern, which has an alternating orientation of the polarization state transmitted.

According to the present invention it can be provided that the arrangement of patterned polarization filters provides a pattern of orthogonal polarization states, which is a fixed pattern along the vertical direction (y direction) and the horizontal direction (x direction), where along the depth direction (z direction) the pattern is inverted and is used in an alternating way.

Object points can be generated at different grids in space. In the three-dimensional space depth planes of the object can have alternating allocation patterns. This means that an object point, which has the same x-coordinate and the same y-coordinate but which are placed at adjacent depth planes, can preferably have orthogonal polarization states. In other words, the allocation pattern to a depth plane of the object representing the polarization state can be used along the z-coordinate in an alternating way. Thus, the polarization states are inverted for adjacent z-planes. However, the simplest way might be to use a fixed pattern along the vertical direction and the horizontal direction and invert it in an alternating way along the z-coordinate (depth coordinate), which is the distance to the observer or the distance of the different z-planes in which the object is divided.

In a further advantageous embodiment of the present invention it can be provided that the display device comprises a non-patterned retarder arranged behind the spatial light modulator device, seen in the propagation direction of light, for providing light having a single exit polarization state containing two mutually incoherent wave fields.

Adding a non-patterned retarder, which can be designed preferably as a polarizing filter, arranged behind the SLM provides a single exit polarisation state of the light, which contains two mutually incoherent wave fields. These two mutually incoherent wave fields comprise or carry a part of the three-dimensional (3D) object or scene.

Furthermore, the display device according to the present invention can be provided in such a way that in the calculation of the sub-hologram representing the object point a wedge function is used for laterally shifting the object point within a defined angular range.

For the realization of two orthogonal polarizations it is possible to encode a wedge function in the sub-hologram, which might laterally shift object points within the angular range spanned by the viewing window in the observer plane. For a two-dimensional (2D) encoding of a hologram into the SLM, the encoding of the wedge function can be done along the vertical direction as well as for the horizontal direction. In other words, a left and a right separation of e.g. a quadratic/square area of a pixel can generate a horizontal separation, which is a left and a right separation of adjacent orthogonally polarized retinal point spread functions. An upper and a lower separation of the area of the pixel can generate a vertical separation, which is an upper and lower separation of adjacent orthogonally polarized retinal point spread functions. This can also be applied to a rectangular shape of the pixel or any other suitable pixel shape.

In contrast to a one-dimensional (1D) encoding of holograms, the two-dimensional (2D) encoding of holograms offers the possibility of realization of arbitrary shaped two-dimensional phase wedge functions. Only a subset of the potential two-dimensional wedge distributions is needed. That is to say, the wedge function can be an arbitrary shaped two-dimensional phase wedge function.

In a further embodiment of the present invention it can be provided that the relative phase of complex values of wavefronts for the individual object points is defined in such a way that the difference between the total intensity distribution in the eye of the observer generated by the point spread functions representing adjacent object points of the object and the target intensity distribution is minimized. By means of a calculation of the object points on the retina can this be carried out. The intensity on the retina is reduced on areas where there is too much intensity, and the intensity is increased on area where there is too low intensity. In other words, the real distribution of the intensity is adapted to the target distribution of the intensity.

The relative phase, i.e. the mutual phase difference, of the individual object points of the object or of the scene might be chosen in a way to minimize the difference of the “should be/target intensity distribution in the plane of the retina of the eye of the observer I(X,Y)_retina” and the “is/total intensity distribution in the plane of the retina of the eye I(X,Y)_retina”. By using of an analytic model the optimum phase and intensity can be calculated directly. If such an analytic model cannot be used, the following procedure can be used. An optimized image, in which retinal inter object point crosstalk is not yet considered, can propagate in the model to the retina, e.g. by using of the wave propagation method (WPM) or by using of a Fresnel transformation. After this, the deviation between the target intensity distribution and the total intensity distribution is determined. In a next step the phase of individual object points can be modified or varied in such a way that the deviation is reduced. The procedure can be iterative. This concerns an additional iteration during the calculation of the optimum complex values of the spatial light modulator.

The amplitude of complex values of wavefronts for the individual object points can be advantageously defined in such a way that the difference between the total intensity distribution in the eye of the observer generated by the point spread functions representing adjacent object points of the object and the target intensity distribution is minimized. By means of a calculation of the object points on the retina can this be carried out. The intensity on the retina is reduced where there is too much intensity, and the intensity is increased where there is too low intensity. In other words, the real distribution of the intensity is adapted to the target distribution of the intensity.

The intensity, i.e. the amplitude of the complex values of the wavefronts, of the individual object points might be chosen in a way to minimize the difference of the “should be/target intensity distribution in the plane of the retina of the eye of the observer I(X,Y)_retina” and the “is/total intensity distribution in the plane of the retina of the eye I(X,Y)_retina”. By using of an analytic model the optimum phase and intensity can be calculated directly. If such an analytic model cannot be used, the following procedure can be used. An optimized image, in which retinal inter object point crosstalk is not yet considered, can propagate in the model to the retina, e.g. by using of the wave propagation method (WPM) or by using of a Fresnel transformation. After this, the deviation between the target intensity distribution and the total intensity distribution is determined. In a next step the amplitude of individual object points can be modified in such a way that the deviation is reduced. The procedure can be iterative. This concerns an additional iteration during the calculation of the optimum complex values of the spatial light modulator.

In other words, an iterative optimization can be chosen. In which direction the relative phasing between two object points has to be shifted in order to arrive closer at the target intensity distribution depends on the image content to be encoded. The superposition is analytical. In this way, one point and other points, too, can be generated mathematically. A neighboring point to one point can be positioned analytically. That is to say, an image can be generated along an edge of said image.

Alternatively, it could also be used an initial encoding, where this initial encoding is then optimized iteratively. In the process, the deviation or difference to the target intensity distribution or to the target image should be checked. A threshold value is provided to stop the iteration.

Further, it can be provided advantageously an apodization profile or apodization function. The apodization profile can be provided in the plane of the pixels of the spatial light modulator device to achieve apodized sub-holograms of the individual object points of an object.

In the case of object points that might be reasonable large, i.e. for example ≤HD/2 (half of the maximum resolution), the object point might be modified in a way to minimize the difference of the “should be/target intensity distribution I(X,Y)_retina” and the “is/total intensity distribution I(X,Y)_retina”. This can be carried out by means of apodized sub-holograms representing the object points, which are formed within the plane which will be picked up by the point spread functions of the eye. All object points the observer is looking at are generated by the SLM. Thus, the complex-valued intensity distribution present in the sub-holograms of the SLM can be used in order to generate point spread functions having reduced side lobes. This means e.g. to use apodized sub-holograms, which are able to generate point spread functions on the retina of the eye of the observer. These point spread functions should be no Airy distributions but e.g. Gauss distributions, which do not have any side lobes. Side lobes in the intensity distribution of object points can be suppressed or even influenced in their shaping in such a way that the difference of the “should be/target intensity distribution I(X,Y)_retina” and the “Is/total intensity distribution I(X,Y)_retina” is minimized. However, side lobes can also be increased to do so if in the superposition a lower deviation to the target intensity distribution on the retina can be achieved.

This practice could be applied better to reasonable large object points. However, it is not limited to that application. The changes in the intensity of the side lobes are not so efficient for very small object points and resultant large sub-holograms.

The apodization function for a sub-hologram can be a(x,y)_SLM (apodization function in the plane of the SLM and a phase(x,y)_SLM (apodization function in the plane of the SLM) too, which means a c(x,y)_SLM (apodization function in the plane of the SLM). Thus, the apodization function used within the SLM plane can be complex-valued.

In a further embodiment of the present invention it can be provided that the sub-holograms of the SLM are modifiable in their shapes.

The sub-holograms of the SLM can have any shape. The outer shape of the sub-holograms can be varied. Such a parameter variation changes the shape of the retinal point spread function of individual object points. It could be used e.g. a round or quadratic/square shape, where every other practical shape could also be used. Especially for a two-dimensional (2D) encoding a shaping of the object points by using a modified shape of the sub-holograms can be used. The shape of the sub-holograms can be adapted according to the object points. The adapted shape is related to the c(x,y)_SLM which might e.g. use a fixed round or quadratic shape only. The character “c” means it concerns a complex value.

Preferably, it can be provided that a fixed predefined grid of point spread functions provided in the eye of the observer is used.

A fixed grid of point spread functions PSFᵢⱼ can be used in order to optimize the side lobes in the intensity distribution generated by the object point. This fixed grid of point spread functions can also be used to optimize the relative phase difference and the intensity of the point spread functions PSFᵢⱼ. With such optimizations a reconstructed retinal image can be obtained, that is reasonable close to the target retinal image of the three-dimensional (3D) scene. The suffixes ij regarding the point spread functions PSFij are indices indicating points of a two-dimensional grid, preferable the points placed at the two-dimensional, spherical curved one of the retinal receptors.

It can further be provided that the illumination unit is adapted in such a way to emit two orthogonally polarized wave fields, preferably by using a wire grid polarizer structure.

The illumination unit can comprise means for emitting of two orthogonally polarized wave fields or can be adapted for it. Preferably such means can be e.g. a wire grid polarizer structure or a wire grid polarizer, preferably a two-dimensional wire grid polarizer structure. The wire grid polarizer structure can be implemented as a mirror of two mirrors provided in the illumination unit, which are used at the ends of a resonator of at least one light source of the illumination unit. The at least one light source can be e.g. a laser or a laser diode. The period of this special wire grid polarizer structure is usually smaller than π/2n, where π is the laser (laser is used in this context for the used light source, I.e. It could also be a laser diode or an LED) wavelength and n is the corresponding refractive index of the substrate/structure of the wire grid polarizer. Two linear orthogonal polarization states have a maximum reflectivity by using the wire grid polarizer structure, the reflectivity is close to 1 (100%). A metallic, two-dimensional striped wire grid polarizer structure can be enhanced in its reflectivity by adding a dielectric layer stack. Such a two-dimensional wire grid polarizer structure can also be used in the illumination unit. For instance, the wire grid polarizer structure or another kind of mirror can be used at the end of a light source cavity of the illumination unit in order to provide e.g. two orthogonal linear exit polarization states.

The illumination unit can comprise at least one light source, preferably a laser or a laser diode, provided to generate a wave field. The illumination unit can comprise at least one light source per primary color. It can also be provided that the illumination unit comprises a stripe-like light source arrangement.

Preferably, per primary color RGB (red, green, blue) at least two mutually incoherent light sources can be provided.

According to the invention it can be further provided that the spatial light modulator device is illuminated with an angular spectrum of plane waves of ≤ 1/60 degrees along the coherent direction and 0.5 to 1 degrees along the incoherent direction.

The spatial light modulator device can be illuminated with an angular spectrum of plane waves of e.g. 0.5 to 1 degrees horizontally, which is the incoherent direction. That is sufficient to span a horizontal sweet spot in the observer plane. The angular spectrum of plane waves is preferably significantly smaller than 1/60 degrees, which means e.g. 1/120 degrees only, along the vertical direction, which is the coherent direction or In other words the direction of the sub-hologram encoding of the one-dimensional (1D) encoded holographic three-dimensional (3D) display device. Depending on the required case the coherent direction could also be the horizontal direction and the incoherent direction could be the vertical direction.

Advantageously, it can be provided that the mutual coherence field is limited to a maximum extension, the maximum extension is the size of the largest sub-hologram in the spatial light modulator device.

Regarding the light source used the coherence of the light emitted by the light source has to be as low as possible but as high as required for a holographic encoding of object points into the spatial light modulator device. The observer window in the observer plane can be tracked by a tracking device if the observer moves to another position. The tracking angle to be required for tracking the observer window and additional diffractive optical elements in the light path of the display device according to the invention introduce an optical path difference within an area relating to the extension of the sub-holograms on the spatial light modulator device. This is a reason for a line width of the light source of the illumination unit of ≤0.1 nm. In addition to the optical path difference introduced, an increased line width would also introduce a smearing of the objects or scenes in the reconstruction. Such smearing is caused by the diffractive dispersion generated by the diffractive optical elements used in the display device.

The line width of the light source, which preferably has to be ≤0.1 nm, is only one aspect of the coherence properties required. Another aspect is the extension of the spatial coherence or more precisely the absolute value of mutual coherence. The mutual coherence e.g. between adjacent color filter stripes provided in the plane of the pixels of the spatial light modulator device can be eliminated while sufficient coherence of the light, e.g. >0.8, can be provided along the direction of the color filter stripes. In addition, the mutual coherence field, which is tailored to be e.g. a one-dimensional line-like segment, that can be orientated in parallel to the color filter stripes, is limited to a maximum extension. The maximum extension can have the size of the largest sub-hologram.

For example, for specifying the maximum of the optical path difference and thus the line width of the light source used or the maximum extension of the mutual coherence the size of the viewing window and its projection onto the spatial light modulator device, where such a procedure can be used to define the size of the sub-hologram on the spatial light modulator device, has not to be considered. However, the entrance pupil of the human eye should be used or considered in order to specify this and to get sufficient parameters for the lowest possible coherence of the light.

The spatial light modulator device can advantageously be designed as a complex-valued spatial light modulator device. Such a complex-valued spatial light modulator device should be able to reconstruct different incoherent object point subsets relating to different primary colors (RGB).

The present invention describes a display device using a single spatial light modulator device (SLM) only, which enables the reconstruction of different incoherent object point subsets relating to different primary colors at once.

The object of the present invention is also achieved by a method according to claim 31.

The invention refers to a method for optimization of and increasing the image quality of reconstructed two-dimensional and/or three-dimensional objects, where each object includes a plurality of object points. For each object point a sub-hologram is calculated, which is encoded in pixels of a spatial light modulator device. Reconstructed adjacent object points generate adjacent point spread functions in an eye of an observer. The point spread functions are separated by a separator such that the adjacent point spread functions superpose merely incoherently in the eye of the observer in order to eliminate advantageously retinal inter object point crosstalk.

Advantageously, it can be provided that incoherent subsets of wave fields representing the object point to be displayed to the observer are generated and superposed incoherently.

There are now various possibilities for advantageously configuring and refining the teaching of the present invention and/or combining the embodiments described above with one another—as far as is possible. In this regard, reference is made on the one hand to the patent claims dependent on patent claim 1, and on the other hand to the following explanation of the preferred exemplary embodiments of the invention with the aid of the drawing. In connection with the explanation of the preferred exemplary embodiments of the invention with the aid of the drawing, preferred configurations and refinements of the teaching are in general also explained.

In the drawing:

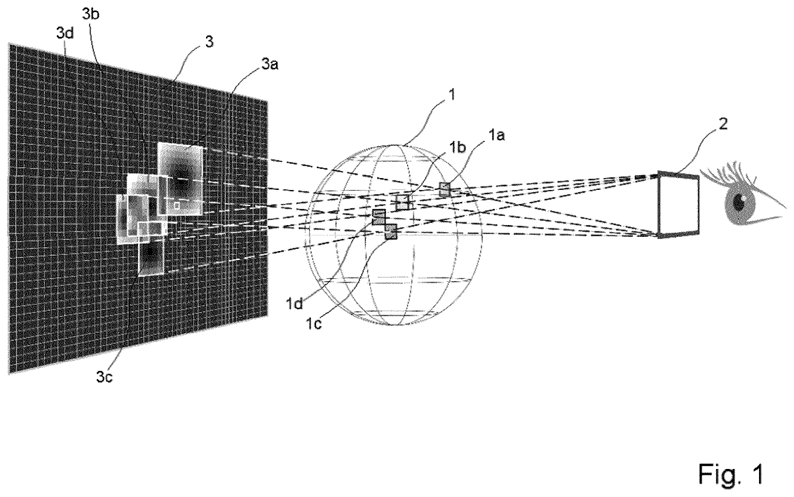

FIG. 1 shows a schematic representation of a display device in connection with a method for the reconstruction of a three-dimensional object with a computer-generated hologram;

FIG. 2 shows intensity distributions of point spread functions, where adjacent point spread functions are superposed, according to the prior art

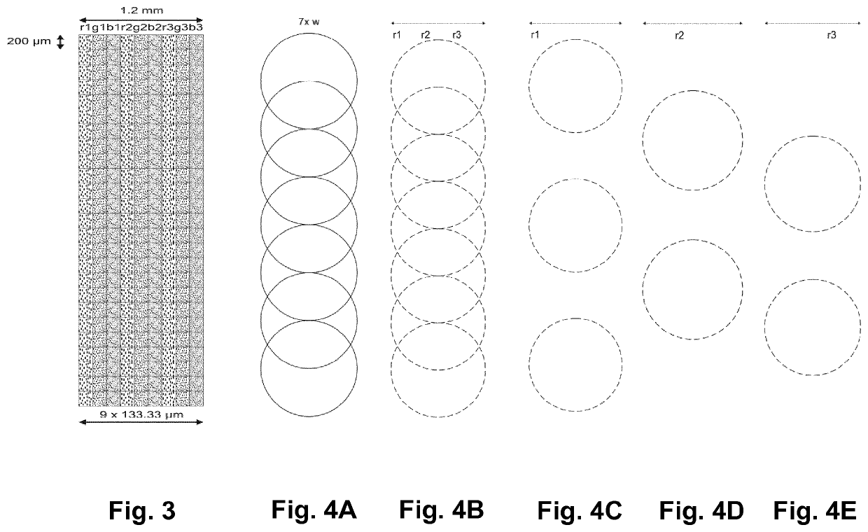

FIG. 3 shows a separator designed as a color filter stripes arrangement according to the present invention,

FIG. 4 shows single lines of seven white object point reconstructed by the part of a spatial light modulator device shown in FIG. 1,

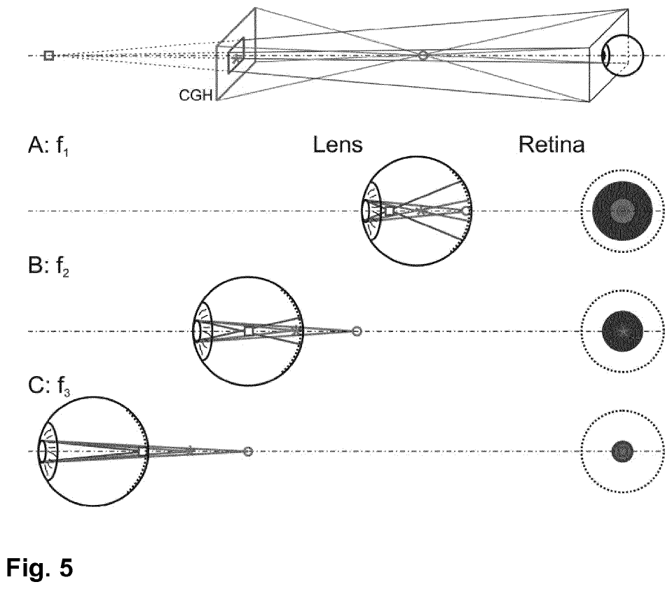

FIG. 5 shows an illustration of a retinal placement of focussed and non-focussed object points by an observer looking at a scene including object points,

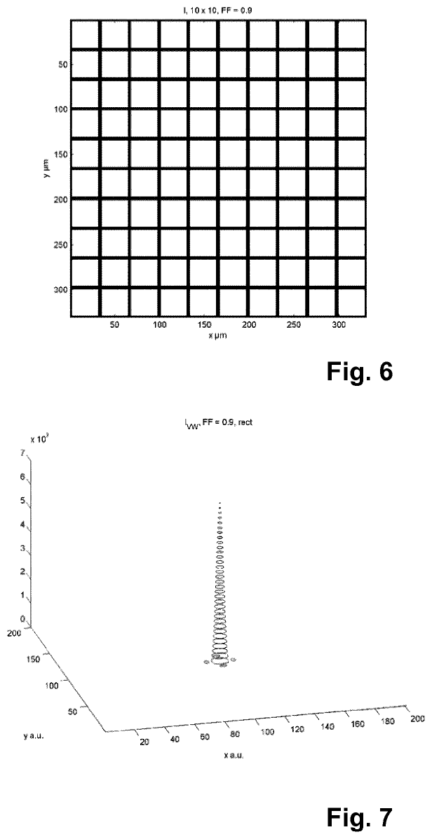

FIG. 6 shows a part of a spatial light modulator device, which means ten times ten pixels, having pixel apertures and a fill factor of 0.9, where a binary amplitude transmission is provided,

FIG. 7 shows an intensity distribution of a Fourier transformation of the intensity distribution shown within FIG. 6 representing the amplitude distribution of a plane of the spatial light modulator device,

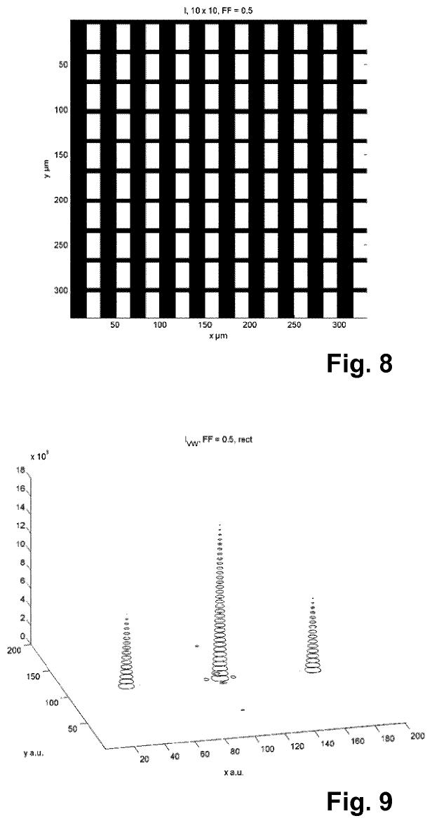

FIG. 8 shows a part of a spatial light modulator device using only the right half of the pixel apertures and a fill factor of approximately 0.5, where a binary amplitude transmission is provided,

FIG. 9 shows an intensity distribution of a Fourier transformation of the intensity distribution shown within FIG. 8 representing the amplitude distribution of a plane of the spatial light modulator device,

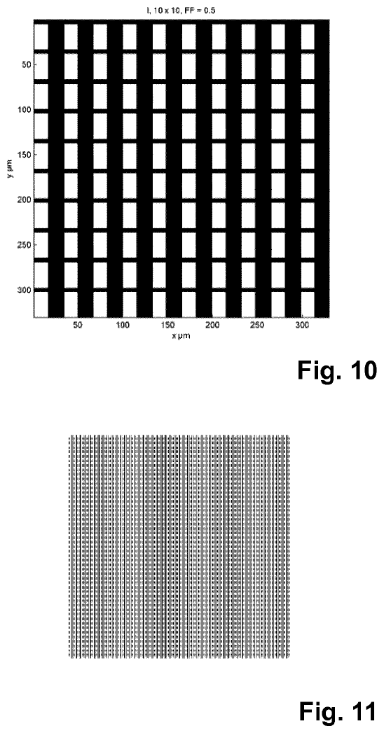

FIG. 10 shows a part of a spatial light modulator device using only the left half of the pixel apertures and a fill factor of approximately 0.5, where a binary amplitude transmission is provided,

FIG. 11 shows an illustration of a two-dimensional wire grid polarizer structure used in an illumination unit of the display device according to the present invention,

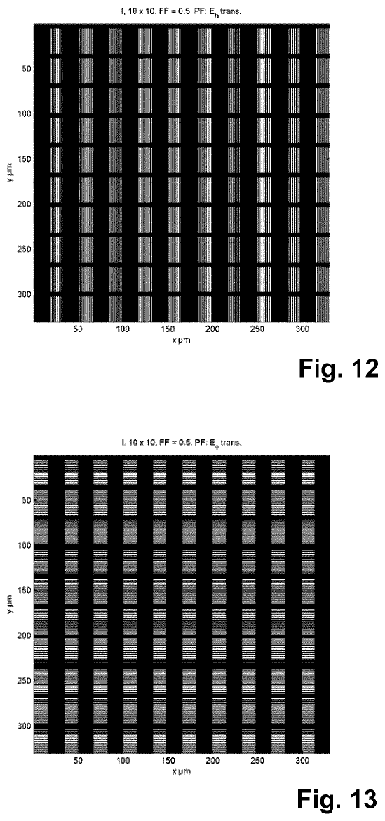

FIG. 12 shows a part of a spatial light modulator device having pixel apertures and a fill factor of 0.5, where a binary amplitude transmission is provided and a patterned polarisation filter for the transmission of a horizontal orientated electrical field is used,

FIG. 13 shows a part of a spatial light modulator device having pixel apertures and a fill factor of 0.5, where a binary amplitude transmission is provided and a patterned polarisation filter for the transmission of a vertical orientated electrical field is used,

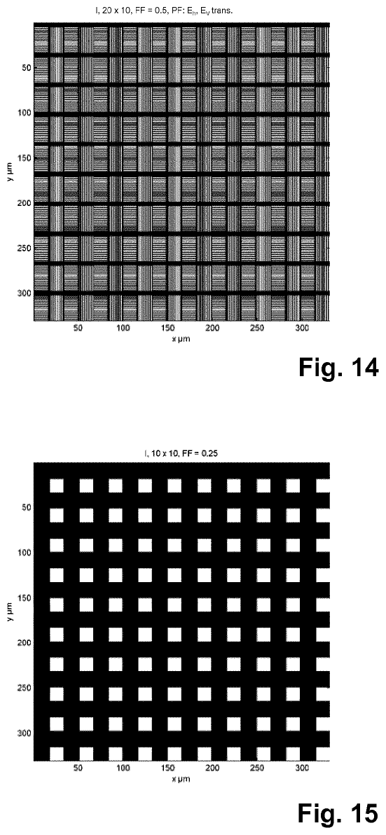

FIG. 14 shows a part of a spatial light modulator device provided with an arrangement of patterned retarders, where two subsets of a pixel of the spatial light modulator device are nested, where the two subsets have orthogonal exit polarization states,

FIG. 15 shows a part of a spatial light modulator device having pixel apertures and a fill factor of approximately 0.25, where a binary amplitude transmission is provided,

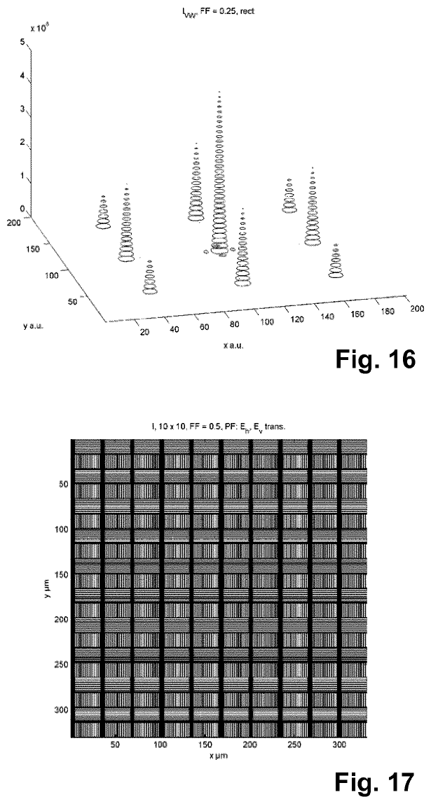

FIG. 16 shows an intensity distribution of a Fourier transformation of the intensity distribution shown within FIG. 15,

FIG. 17 shows a part of a spatial light modulator device provided with an arrangement of patterned retarders, where two subsets of a pixel of the spatial light modulator device are nested orthogonal to the one of FIG. 14, where the two subsets have orthogonal exit polarization states,

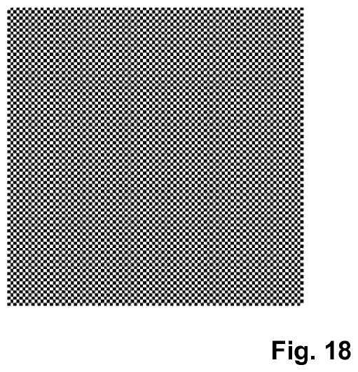

FIG. 18 shows an illustration of a checkerboard-like allocation pattern of orthogonal polarization states, which refers to three-dimensional object points reconstructed in space or at a retina of an eye of an observer.

Like reference designations denote like components in the individual figures and accompanying description, if provided. In the following, the designations “in front of” and “behind”, e.g. in front of the spatial light modulator device, mean the light seen in regards to the propagation direction of the light.

A display device for the holographic reconstruction of two-dimensional and/or three-dimensional scenes or objects comprises a spatial light modulator device 4 and an illumination unit 5. The scene or the object includes a plurality of object points as shown in FIG. 1. FIG. 1 schematically represents the encoding of a scene or object into the spatial light modulator device 4. A three-dimensional object 1 is constructed from a plurality of object points, of which only four object points 1a, 1b, 1c and 1d are represented here in order to explain the encoding. A virtual observer window 2 is furthermore shown, through which an observer (indicated here by the eye represented) can observe a reconstructed scene. With the virtual observer window 2 as a defined viewing region or visibility region and the four selected object points 1a, 1b, 1c and 1d, a pyramidal body is respectively projected through these object points 1a, 1b, 1c and 1d and in continuation onto a modulation surface 3 of the spatial light modulator device 4 (only represented partially here). In the modulation surface 3, this results in encoding regions in the spatial light modulator device 4, where the shape of the encoding region has not to be corresponded with the shape of the viewing window 2. That is to say, the encoding region on the spatial light modulator device 4 can also be larger or smaller as specified by the projection of the viewing window 2 through the object point onto the modulation surface 3. The encoding regions are assigned to the respective object points 1a, 1b, 1c and 1d of the object, in which the object points 1a, 1b, 1c and 1d are holographically encoded in a sub-hologram 3a, 3b, 3c and 3d. Each sub-hologram 3a, 3b, 3c and 3d is therefore written, or encoded, in only one region of the modulation surface 3 of the spatial light modulator device. As can be seen from FIG. 1, depending on the position of the object points 1a, 1b, 1c and 1d, the individual sub-holograms 3a, 3b, 3c and 3d may overlap fully or only partially (i.e. only in certain regions) on the modulation surface 3. In order to encode, or write, a hologram for the object 1 to be reconstructed into the modulation surface 3 in this way, the procedure described above must be carried out with all object points of the object 1. The hologram is therefore constructed from a multiplicity of individual sub-holograms 3a, 3b, 3c, 3d, . . . 3ₙ. The holograms computer-generated in this way in the spatial light modulator device are illuminated for reconstruction by the illumination unit 5 (only schematically illustrated) in conjunction with an optical system.

With reference to FIG. 1, the individual sub-holograms 3a, 3b, 3c and 3d within the section of the hologram defined by the encoding regions have an essentially constant amplitude, the value of which is determined as a function of brightness and distance of the object points, and a phase which corresponds to a lens function, the focal length of the lens as well as the size of the encoding regions varying with the depth coordinate of the object point. Outside the section defined by the encoding regions, the amplitude of the individual sub-hologram has the value 0. The hologram is obtained by the complex-valued sum of all sub-holograms 3a, 3b, 3c, 3d . . . 3ₙ.

The illumination unit 5 can contain several specific modifications to be used preferably within a holographic display device. The illumination unit can be used for coherent light and for light which only shows reduced spatial and/or temporal coherence. Amplitude apodization and phase apodization can be used to optimize the intensity profile which propagates behind the entrance plane of the illumination unit 5. Color filters give the opportunity to optimize this for different colors separately. The specifications are dependent on the discrete embodiment.

In the following, it will be described and explained the suppression of retinal inter object point crosstalk that reduces the image quality of the reconstructed scene or object point. This retinal inter object point crosstalk is caused during the holographic reconstruction of the three-dimensional scene or object.

There is a plurality of parameters to be optimized in the display device in order to obtain a required image quality. One parameter to be considered is the diameter of the entrance pupil of the human eye. For this, a priori knowledge of the points spread function is used, which is close to the real situation that applies to an observer watching a holographic three-dimensional scene. Data obtained by using an eye tracking and eye detecting system, which detects the position of an eye of an observer at a defined position relating to the display device, can be used. The diameter of an entrance pupil of the eye of the observer depends on the luminance of the scene or object the observer is watching. Thus, values might be used that refer to the present luminance of the scene or the object. Furthermore, the pictures provided by the eye tracking and eye detecting system comprising at least one camera for recording the position of the observer and especially for recording the entrance pupil of the eye of the observer can also be used to extract a more exact value of the diameter of the entrance pupil of the eye of the observer.

In principle, the eye of an observer might have an Airy shaped point spread function which is used to “pick up” the three-dimensional field emanating from an object. If the eye of the observer is focussed on an object point that is placed e.g. at 1 m, the point spread function of the object point placed at said 1 m and imaged on the retina of the eye is smaller than the point spread function of an object point e.g. placed at 0.8 m and smaller than the point spread function of an object point placed at 1.5 m. In other words, the object points the observer is focussing on are transferred to the retina of his eye with the smallest point spread function. However, object points out-of-focus or even only slightly out-of-focus have larger point spread functions as point spread functions of object points in-focus. Defocusing means widening the point spread function of the corresponding defocussed object plane.

These “pick up and wave transfer” functions, i.e. the point spread functions of the plane on that is focussed, of the wave fields of all object points of an object have to pass the same entrance pupil of the eye of the observer. Due to fact that the adjacent object points of the object on which the observer is watching are very close to each other, the transfer wave fields emanating from these object points hit the entrance pupil of the eye of the observer at the same location or place and at approximately the same angle. Thus, the phase function of the entrance pupil of the eye which has to be considered is the same. In other words, there is a common path arrangement here. The complex-valued point spread functions of adjacent object points, which are picked up and transferred to the retina, are the same. Otherwise, for object points that are very far apart slightly different point spread functions have to be considered. For example, for the transfer of object points close to the optical axis of the display device, a narrower point spread function can be used as for object points at the edge of the image that are transferred with a slightly broader point spread functions.

For minimizing the retinal inter object point crosstalk between adjacent object points of an object the following parameters should be modified:
I) the relative phase emanating from the object point,
II) the relative amplitude emanating from the object point, and
III) the lateral position or distance of the adjacent object points to each other, which can be shifted slightly within the angular range of two adjacent diffraction orders. That is to say, a small phase wedge is used with which object points in a range of e.g. ± 1/60 degrees or ± 1/40 degrees can be shifted. Thus, it is differed slightly from an equidistant dot matrix.

For optimizing the image quality of the reconstructed object or scene, the object or the scene is divided into individual depth planes before carrying out the holographic reconstruction. These values for the relative phase, the relative amplitude and for the lateral position have to be optimized for each single discrete depth plane, e.g. 128 depth planes, for a set of entrance pupil diameters as e.g. 2 mm, 2.2 mm, 2.4 mm, . . . 3.6 mm which are correlated with the luminance presented to the eye and for each primary color RGB (red, green, blue). Thus, a generated data set including optimized values for the relative phase, for the relative amplitude and for the lateral position can be saved in a look-up table (LUT). These generated data sets can be included in the calculation of the sub-holograms to be encoded in the spatial light modulator device.

A first approach for determination of an assumable aperture of a pupil of an eye of an observer might use the average luminance to be able to choose the entrance pupil diameter which might be at least within the right range, e.g. for television 50-250 cd/m², for a desktop monitor 100-300 cd/m². The luminance intensity can be calculated from the image content. A second approach might use the data of an eye tracking system to measure the entrance pupil diameter and to choose the right data sub set of the look-up table.

During the calculation of a sub-hologram corresponding to an object point as one possibility for optimizing the parameters above the average luminance can be used to choose the entrance pupil diameter of the eye which might be substantially within a required range, e.g. between 25 cd/m² and 1000 cd/m². Another possibility can be to use the obtained data of an eye tracking and detecting system. With these data the entrance pupil diameter can be measured and the required data subset of the look-up-table can be chosen, In other words, an image recorded by a camera of the eye tracking and detecting system in connection with the distance measurement can be used to determine the diameter of the pupil.

A further possibility might be to use the distance of the entrance pupils of the eyes of an observer to define the rotation angle of the two optical axes of the eyes. In this way the point of intersection of the two optical axes which is in the focal distance of the eyes can be determined. For this an individual calibration for each observer might be required. This can be done by implementing a calibration routine which is processed by each observer once.

However, only a limited set of parameters can be modified or adapted or altered.

An example is the plurality of object points which might be real and thus in front of a display device. The eye of an observer might be focussed on this plane(s) of object points. The point spread function of the eye of the observer picks up these object points and transfers them to the retina of the eye of the observer.

There are several options to proceed, where the options can be combined if necessary or required or suitable:

1)

A single object point can be shifted virtually in his depth plane in such a way that the difference of the “should be/target intensity distribution on the retina of the eye of the observer I(X,Y)_retina” and the “Is/total intensity distribution on the retina of the eye of the observer I(X,Y)_retina” is minimized, where I is the intensity distribution in the plane of the retina of an eye and x and y are the coordinates within the retina of the eye, which is referred to values of an x-axis and a y-axis. This can be done by introducing small offset phase functions in the calculation of the sub-holograms to be encoded into the spatial light modulator device, in the following also referred to as SLM. Shifts of object points within an angular range of a one-dimensional or two-dimensional viewing window provided in the observer plane are irrelevant for the present invention.

2)

The relative phase or more precisely the mutual phase difference of the individual object points can be chosen in such a way that the difference of the “should be/target intensity distribution on the retina of the eye of the observer I(X,Y)_retina” and the “is/total intensity distribution on the retina of the eye I(X,Y)_retina” is minimized. For this, the eye of an observer is included in the calculation process. The generation of the image is calculated on the retina. Thus, the retina is the reference plane. The starting point is a scene to be encoded. An iterative optimization of the image on the retina can be carried out. In a first step all sub-holograms can be added and propagated to the retina. Then, the deviation of the total intensity distribution on the retina to the target intensity distribution on the retina can be determined. The phase, the amplitude and the position can be changed. The deviation can be redetermined. This can be carried out by using an iterative loop. A threshold of deviation can be chosen as termination condition, e.g. if the deviation is smaller than 5%. It is also possible to limit the number of iterations.

3)

The intensity or the amplitude of the individual object points can be chosen in such a way that the difference of the “should be/target intensity distribution on the retina of the eye of the observer I(X,Y)_retina” and the “is/total intensity distribution on the retina of the eye I(X,Y)_retina” is minimized. For this, the eye of an observer is included in the calculation process. The generation of the image is calculated on the retina. Thus, the retina is the reference plane. The starting point is a scene to be encoded. An iterative optimization of the image on the retina can be carried out. In a first step all sub-holograms can be added and propagated to the retina. Then, the deviation of the total intensity distribution on the retina to the target intensity distribution on the retina can be determined. The phase, the amplitude and the position can be changed. The deviation can be redetermined. This can be carried out by using an iterative loop. A threshold of deviation can be chosen as termination condition, e.g. if the deviation is smaller than 5%. It is also possible to limit the number of iterations.

4)

For reasonable large object points, which may be e.g. as large as 50% of the point spread functions which pick up the object points and transfer them to the retina of the eye of the observer, the object point can be modified in such a way that the difference of the “should be/target intensity distribution on the retina of the eye of the observer I(X,Y)_retina” and the “Is/total intensity distribution on the retina of the eye I(X,Y)_retina” is minimized. This can be done e.g. by using apodized sub-holograms representing the object points which are provided within the plane that is picked up by the point spread function of the eye. All object points the observer is watching are generated by the SLM. Thus, the complex-valued distribution present in the sub-holograms of the SLM can be used in order to generate point spread functions with reduced side lobes. This can be carried out by using apodized sub-holograms, which are able of generating point spread functions at the retina of the eye of the observer. The point spread functions should be no Airy distributions but e.g. Gauss distributions that do not have any side lobes.

Side lobes in the intensity distributions generated by the object points can be suppressed or even formed in a way to minimize the difference of the “should be/target intensity distribution on the retina of the eye of the observer I(X,Y)_retina” and the “is/total intensity distribution on the retina of the eye I(X,Y)_retina”. Side lobes can also be increased to do so. Side lobe shape variation is used as a further parameter variation, which can reduce the difference of the total intensity distribution to the target intensity distribution on the retina of the eye of the observer I(X,Y)_retina.

Such procedure may work more efficiently for reasonable large object points of the object or scene. The changes in the difference of the “should be/target intensity distribution on the retina of the eye of the observer I(X,Y)_retina” and the “Is/total intensity distribution on the retina of the eye I(X,Y)_retina” may not be very efficient if very small object points and thus large sub-holograms are used.

The sub-hologram apodization can be an a(x,y)_SLM (Amplitude-SLM) and a phase(x,y)_SLM (Phase-SLM) too, which result in a c(x,y)_SLM (complex-valued SLM). Thus, the apodization used within the SLM plane can be complex-valued.

5)

For a two-dimensional (2D) encoding it is possible to shape the object points by using a modified shape of the sub-holograms used. The adapted shape of the sub-holograms is related to the complex-valued SLM c(x,y)_SLM, which e.g. uses a fixed round or quadratic/square shape only. For example, it can also be used hexagonal sub-holograms or sub-holograms that are slightly changed in the aspect ratio. In general, the complex-valued distribution can be varied. The parameters used may be dependent on the content of the three-dimensional scene. This means that the complex-valued distribution of the apodization of the sub-holograms may be changed in regard to the change of the content. In other words, the distribution of phase and amplitude of the individual sub-holograms can be varied.

6)

If it is not possible to realize an overall optimization of the reconstructed object or scene, which includes e.g. all z-planes, where z is the longitudinal distance parallel to the optical axis of the display device, then vergence (gaze) tracking can be used to define the depth plane of interest. For this, it is determined what does the observer look at or gaze at. The eye tracking and detecting system can determine that look or gaze so that the look of the observer can be defined. Thus, the results for the encoding of the sub-holograms into the SLM can be optimized in regard to the z-plane or to the range of z-planes the observer is watching.

The options explained under 1) to 6) can be combined with each other to achieve a good or required high quality.

Although these options mentioned before can be combined, the most direct way or the more practical way is to use a fixed grid of point spread functions PSFᵢⱼ and to optimize the side lobes, the relative phase difference and the intensity of the point spread functions PSFᵢⱼ in order to get a reconstructed retinal image, that is reasonable close to the designed retinal image of the three-dimensional object or scene. The suffixes ij regarding the point spread function PSFᵢⱼ are indices indicating points of a two-dimensional grid, preferable a virtual grid, placed at the two-dimensional, spherical curved detector plane or surface of the retina.

In the following the present invention is described for one-dimensional (1D) encoded holograms in an SLM:

In general, the options 1) to 6) described above can be used additionally to the following options for one-dimensional encoded holograms. Thus, the side lobe suppression, the retinal inter object point crosstalk reduction and the optimization in regard to the image quality can further be enhanced. The following explanations refer to one dimension only. The optimization of the retinal image in only one dimension, which means to analyse and optimize the nearest neighbours of the point spread function PSFⱼᵢ in only one dimension, can be realized faster than optimizing neighboured point spread function PSFᵢⱼ in two dimensions. For this reason, an e.g. iterative optimization or analytic optimization can be carried out in real time. This is fast and efficient enough for active user interaction as in gaming too.

Using the limited angular resolution of the human eye, i.e. of an eye of an observer, is one option that can be used for one-dimensional encoded holograms in an SLM. For that, several one-dimensional encoded lines of object points, which are incoherent to each other and which are seen as one encoded line, are provided. Thus, the pixel density of the incoherent direction on the SLM is increased. Each one-dimensional encoded line generates e.g. ⅓th of the object points which are presented to the observer at 1/60 degrees. A pixel density of e.g. up to 180 pixels per degree or less is used within the incoherent direction to reduce the crosstalk between adjacent object points which may be seen by the observer.

By way of example, the angular resolution of the human eye, which is 1/60 degrees in best case conditions, is equivalent to a lateral extension of objects points that can be resolved. At an average viewing distance of 3.5 m to the display device, which may be assumed generally for a television (TV), 1/60 degrees is equivalent to 1.02 mm lateral extension of two objects points to each other. Although the real resolution is significant less, a periodic interval of for instance 1.2 mm may be used as resolution limit for television applications. Real resolution mean in this context that the luminance is not provided for the best case situation or that individual aberrations of the observer eye may reduce the effective resolution obtained. This value of 1.2 mm was chosen here just to make the example as simple as possible. If a vertical holographic encoding is used, which means vertical parallax only (VPO), the sub-holograms are arranged as vertical stripes on the SLM.

Color filters can be used to reduce the frame rate mandatory for the SLM providing the complex-modulated wave field. As generally known absorptive type dye based filter arrays can be used for that, which are structured aligned to the SLM pixels. Modern coating technology makes it possible to apply notch filters e.g. in a striped arrangement too. This means that a color stripe can reflect two of the primary colors RGB while transmitting the remaining primary color. This can be done with a transmission coefficient greater than 0.9, while reflecting the two non-required wavelengths of this specific stripe with a coefficient close to 1.

For example, it can be assumed to provide three color filter stripes within a horizontal width of 1.2 mm, which is reasonable close to the best case resolution limit of the human eye ( 1/60 degrees) at 3.5 m viewing distance as explained above.

In the prior art it is known to use three color filter stripes within this width of 1.2 mm. Thus, there are three RGB color filter stripes with a width of 400 μm each. The red, the green and the blue color filter stripe have hence a width of 400 μm each.

According to FIG. 3, the density of the vertical stripes is increased much further. The density of the vertical stripes is e.g. two times, three times (3×) or four times (4×) higher than the density according to the prior art. Now, there are two, three or even four pairs or RGB color filter stripes within this exemplary width of 1.2 mm. This means that there are color stripes with a width of 133.3 μm or 100 μm only.

A condition for holographic display devices, which use diffractive components with e.g. a 40 degrees overall accumulated diffraction angle, is a line width of <0.1 nm of a light source of an illumination unit. Furthermore, anti-reflection coatings used, which, for example, can be applied to transparent surfaces of a backlight of the illumination unit, at grazing incidence of light and spectral selectivity of Bragg diffraction-based volume gratings used in the display device provide a stability of the center wave length of 0.1 nm of the light source. This can be achieved e.g. with diode pumped solid state (DPSS) lasers as light sources, which are e.g. available at 447 nm, 457 nm, 532 nm, 638 nm and 650 nm at an optical power of >500 mW each. Furthermore, light sources as distributed feedback (DFB) laser diodes, which have a Bragg resonator grating within the active medium or reasonable close to that medium, or wavelength stabilized laser diodes, which make use of external Bragg resonators, can also fulfill these requirements.

If the switching time of the light source, e.g. laser diodes, has to be reduced, e.g. to 1 ms, for any reasons, additional mechanical shutter or temporal synchronized color filter wheels, which are known from projectors, may be used in the illumination unit. Distributed feedback laser diodes show reasonable fast switching and can be made with different design wavelengths. Furthermore, so called Q-switched laser arrangements can be used in combination with wavelength stabilizing Bragg resonator approaches. This shows that practically available laser light sources can be used for the display device according to the invention.

At a 3.5 m distance from a viewing window in an observer plane to the display device a vertical viewing window of 8 mm would require a pixel size of 195.6 μm on the SLM. This means an approximately pixel size of 200 μm. Thus, the vertical pixel pitch is larger than the horizontal pixel pitch.

If it would be used an average viewing distance of 1.5 m only instead of 3.5 m from a viewing window in an observer plane to the display device the given numbers of the pixel dimensions has to be divided by a factor of 2.3. This could be the case in some cases where required. For holographic 1D encoded 3D television applications a 3.5 m distance is, however, more reasonable.

FIG. 3 shows a part of an SLM in the front view. The SLM is provided with a separator for separating adjacent point spread functions in an eye of an observer generated by the sub-holograms of adjacent object points such that the adjacent point spread functions are mutual incoherent to each other. The separator is designed as a color filter arrangement here, preferably a primary color (RGB) filter arrangement. Such a color filter arrangement is provided mainly for a three times high definition (HD) oversampled 1D encoded holographic 3D television display device but could also be provided for a two-dimensional (2D) encoded holographic 3D television display device. Such a display device is designed for an average observer viewing distance of zₘₑₐₙ=3.5 m to the display device. At this viewing distance the horizontal extension of the color filter arrangement of 1.2 mm as shown in FIG. 3 is equivalent to 1/60 degrees, which is the angular resolution of the human eye. In this embodiment of the separator or of the color filter arrangement for each primary color RGB (red, green, blue) three striped color filters r1, g1, b1, r2, g2, b2, r3, g3, b3 are provided and assigned to the part having a horizontal dimension of 1.2 mm of the SLM. In other words, each part having a horizontal dimension of 1.2 mm of the SLM is provided with a color filter arrangement comprising three striped color filters r1, g1, b1, r2, g2, b2, r3, g3, b3 for each primary color RGB. This means, nine striped color filters are provided within the horizontal angular range of 1/60 degrees. The reference signs r1, r2 and r3 denote the red color filter stripes, the reference signs g1, g2 and g3 denote the green color filter stripes and the reference signs b1, b2 and b3 denote the blue color filter stripes. In FIG. 3, different filling pattern mark the color filter stripes of the three different primary colors RGB.

Of course, it is also possible to arrange the color filter arrangement in the horizontal direction if the encoding direction lies in the horizontal direction.

A schematic representation of object points reconstructed by the part of the SLM shown in FIG. 3 is shown in FIG. 4. For explanation seven object points are used.

FIG. 4 A) shows the reconstruction of seven white object points OP of an object at a vertical angular distance of 1/60° deg. The shown circle each marks the first minimum of the intensity distribution of the diffraction pattern of the point spread function present on the retina of an eye of an observer. For the sake of simplicity a circular shape of the object points OP is assumed here. That is only for illustration of this aspect. However, such a circular shape of the object point OP could not be quite correct for one-dimensional encoded holograms, which are identified with the term vertical parallax only.

FIG. 4 B) shows the reconstruction of seven red object points at a vertical angular distance of 1/60 degrees. These seven red object points form the red subset of the white object points according to FIG. 4 A). As shown, the red subset includes all parts that are generated by the color filter stripes r1, r2 and r3.

FIG. 4 C) shows the reconstruction of the part of the red subset that is only generated by the color filter stripe r1. In other words, the color filter stripe r1 generate the red subset of the white object points OP for the first, fourth, seventh, tenth, . . . object point OP according to 4 A). Here it can be seen that the color filter stripe r1 generates red object points, here three red object points that do not superpose.

FIG. 4 D) shows the reconstruction of the part of the red subset that is only generated by the color filter stripe r2. In other words, the color filter stripe r2 generate the red subset of the white object points OP for the second, fifth, eighth, eleventh, . . . object point OP according to 4 A). Also, the color filter stripe r2 generates red object points, here two object points, that do not superpose. The object points generated by the color filter stripe r2 are reconstructed with an offset of half the circle to the object points generated by the color filter stripe r1.

FIG. 4 E) shows reconstruction of the part of the red subset that is only generated by the color filter stripe r3. In other words, the color filter stripe r3 generate the red subset of the white object points OP for the third, sixth, ninth, twelfth, . . . object point OP according to 4 A). Also, the color filter stripe r3 generates red object points, here two object points, that do not superpose. The object points generated by the color filter stripe r3 are reconstructed with an offset of half the circle to the object points generated by the color filter stripe r2.

The procedure according to the color red is applied to the other primary colors green and blue accordingly.

As a consequence, seven white object points are reconstructed by using three primary colors RGB with three laterally displaced color filter stripes, which are allocated to each primary color RGB. Within the horizontal angular range of 1/60 degrees there are provided the vertical color filter stripes denoted by r1, g1, b1, r2, g2, b2, r3, g3 and b3 as can be seen in FIG. 3. For illuminating the SLM having the separator, which is here designed as a color filter stripes arrangement, tailored horizontally incoherent light is used. The spatial coherence of the light used can be e.g. >0.9 along the vertical direction, which is the encoding direction of the sub-holograms. The longitudinal extension of reasonable high coherence, which means close to 1, can be e.g. 5 mm, or 5 mm to 10 mm.

It is important to prepare the mutual coherence of mutual columns of the SLM used for the 1D encoding in a way that adjacent columns are mutually incoherent to each other. This can be done by using a stripe-like light source arrangement in the illumination unit.

As can be seen from FIG. 4, a single line or part of a one-dimensional (1D) encoded holographic display device is divided into three different colors and into additional subsets, which refer to the single primary colors RGB.

As can be seen further from FIG. 4, there is no overlap or superposition between the object points reconstructed from a coherent subset. The circles each show the first minimum of the diffraction pattern of the object point reconstructed, which means the first minimum of the retinal point spread function. Correctly, additional cycles have to be shown or provided, which show the outer side lobes of the point spread function. However, for the sake of clarity only the first minima or the first side lobes are shown in FIG. 4.

In general, no superposition of the individual circles means that sufficient separation of the adjacent point spread functions on the retina of the eye of an observer is provided. However, there might be a small portion of light, which still superposed with two adjacent coherent object points reconstructed. But that has no significant effect on the quality of the reconstructed scene or objects. In addition, these small values of residual errors of the target intensity distribution to be obtained on the retina of the eye of the observer can be considered and used in an optimization algorithm of the optimization process, which approximates the detected retinal image to the target retinal image meaning without recognizable retinal inter object point crosstalk. The algorithm refers to a target/actual comparison and an iterative variation of parameters. Further optimization of the retinal image for avoiding of retinal inter object point crosstalk can be provided by applying e.g. individual or all of the options described and explained above under items 1) to 6).

The described SLM comprising a separator designed as a color filter stripes arrangement is illuminated by the illumination unit having at least one light source emitting an angular spectrum of plane waves of e.g. 0.5 degrees to 1 degree in the horizontal direction. Such an angular spectrum of plane waves is sufficient to span a horizontal sweet spot in an observer plane if the coherent direction is the vertical direction and vice versa. The angular spectrum of plane waves is preferable significantly smaller than 1/60 degrees, e.g. 1/120 degrees only, along the vertical direction, which is the direction of the encoding of the sub-hologram of the one-dimensional (1D) encoded holographic display device for the reconstruction of three-dimensional scenes or objects.

An encoding unit or computation unit provided in the display device splits the content, preferable the high definition (HD) content, of the object point into the subsets accordingly to FIG. 4. Thus, FIG. 4 also shows the instruction for the reassembling of the content to be encoded. Each third point or even each fourth point for a four color filter stripes arrangement within an angular spectrum of plane waves of ≤ 1/60 degrees of a one-dimensional (1D) vertical line on the SLM is assigned to another sub-color filter line of the part of the SLM shown in FIG. 3. This can be simply transferred to a block diagram of an electronic circuit providing a fast reallocation of the individual sub-holograms, which are generated by defined object points in the three-dimensional (3D) space.

The embodiment schematically shown in FIG. 4 describes the situation of a spatial displacement of object points, which are mutually coherent, in the case the observer is focussing on the object points.

FIG. 5 shows a retinal positioning of focussed and non-focussed object points of an object or a scene in the eye of an observer. As can be seen, the energy of non-focussed object points is spread out and will thus generate a retinal background. There is the highest relative blur if the observer looks at the foreground of the three-dimensional (3D) scene. There is the lowest relative blur if the observer looks at the background of the three-dimensional (3D) scene, which means at holographic reconstructed object points that are far away, as e.g. several meters behind the holographic display plane, which is the plane where the computer-generated hologram (CGH) of the sub-holograms are positioned.

FIG. 5 A shows the most relaxed situation. The retinal background, which arises from sub-holograms with the largest negative values of the focal lengths of object points, is widely spread. But this background can be coherently superimposed on the object points the observer is looking at or is focussing. In other words, the observer is looking at the small circle approximately between the eye and the CGH. Therefore, the image of the circle is imaged exactly on the retina of the eye. The non-focussed object points, here illustrated as a rectangle and a star, are also imaged into the eye, but they have not their focus on the retina of the eye. The object point illustrated as rectangle is far behind the display device illustrated as CGH and will thus only result in a widely spread background as can be seen on the right-hand side of FIG. 5.

FIG. 5 B shows the situation where the observer is looking at the star which is provided in the plane of the CGH. The non-focussed object points, illustrated as the rectangle and the star, are also imaged into the eye and behind the eye, but they have not their focus on the retina of the eye.

FIG. 5 C shows the situation where the observer is looking at the rectangle which is provided behind the plane of the CGH. The non-focussed object points, illustrated as the circle and the star, are imaged behind the retina of the eye, so they have not their focus on the retina of the eye.

With providing of a color filter stripes arrangement as a separator on the SLM the mutual coherence between adjacent color filter stripes of the color filter stripes arrangement can be eliminated. For this, a spatial extended light source can be used in the illumination unit. The aspect ratio of the light source to be collimated can be e.g, 1:60. In this manner, there is no coherence in the horizontal direction (no encoding direction). Thus, coherent superposition of adjacent color filter stripes and disturbing the image quality caused in this way can be prevented.

According to the invention, the additional vertical separation introduced by using additional color filter stripes in addition to one set of color filter stripes (only comprising one red stripe, one green stripe and one blue stripe) and thus the higher pixel count eliminate the mutual coherence between object points, which are neighbours along the vertical direction. This effects an additional reduction of the mutual coherence and thus a further reduction of the retinal inter-object point crosstalk.

However, the coherence of inner axial object points still exists. The expression “coherence of inner axial object points” refers to the coherence of object points sharing a common overlap region of their sub-holograms, encoded as one-dimensional (1D) lens line segments. This means that it has not to be dealt with all the other object point crosstalk anymore, despite the crosstalk generated by object points referring to a single color filter, where the object points are positioned behind each other, which means along the z-direction parallel to the optical axis of the display device, and are positioned adjacent to each other, which means in a plane that is perpendicular to the z-axis, in an out-of-focus situation. This means in the situation the observer is looking at a different plane and the plane, which is considered here, is not in focus.

The optimization described above has to be applied to a reduced number of defined object points only. This means, for the color filter stripes arrangement and for a one-dimensional encoding of holograms the optimization is only carried out in one dimension and, for example, only for 3 to 4 neighboring object points.

FIG. 5 also contains the concept of generating a weighting matrix. Such a weighting matrix can be used for the optimization of e.g. phase values given to different object points. In case of FIG. 5 A) the object point far behind the display device and illustrated as rectangle only results in a widely spread background on the retina and might be thus ignored in a first order approach.

In case of FIG. 5 C) the relative phase values of all inline and close to inline objet points relating to the same color filter stripe along the extension of the spatial coherence, which is e.g. 5 mm vertically, have to be optimized accordingly to each other, since the three axial object points are close to each other. Inline means here, for example, within 1/60 degrees three staggered lines are seen as only one line. One option is to set the overlapping sub-holograms of inline object points relating to the same coherent region of a single color filter stripe to the same phase values. However, in general, the phase values, as one parameter only, have to be optimized in regard to the image content displayed. This also includes the relative intensities of overlapped sharp or blurred coherent object points.

The following explanations refer to the illumination unit comprising at least one light source which can be used for a one-dimensional encoding of holograms. The coherence of the light emitted by at least one light source has to be as low as possible but as high as requested for a holographic encoding. A tracking angle to be introduced for tracking a viewing window in an observer plane according to a movement of an observer and additional diffractive optical elements provided in the display device introduce an optical path difference within a region based on the extension of a sub-hologram. Therefore, the line width of the light source designed e.g. as a laser light source to be used has to be s 0.1 nm. In addition to the optical path difference introduced, an increased line width would also introduce a smearing in the reconstruction. The smearing may be due to the diffractive dispersion introduced by the diffractive optical elements used in the display device. In the process all effects sum up.

The line width of the light source of the illumination unit, which has to be ≤0.1 nm, is only one aspect of the coherence. Another aspect is the extension of the spatial coherence or more explicit the absolute value of mutual coherence. The mutual coherence between adjacent color filter stripes can be eliminated as disclosed above while sufficient coherence of the light, e.g. >0.8, can be provided along the direction of the color filter stripes, i.e. along the encoding direction. Additionally, the mutual coherence region, which is tailored to be a one-dimensional line-like segment orientated in parallel to the color filter stripe(s), is limited to a maximum extension according to the size of the largest sub-hologram.

For specifying the maximum of the optical path difference and thus the line width of the light source used or the maximum extent of the mutual coherence not the entire size of the viewing window and its projection onto the SLM, which can be used to define the size of the sub-hologram, has to be considered. It is better to consider only the entrance pupil of the human eye or of the eye of the observer. The entrance pupil of the eye can be used to specify the maximum of the optical path difference and thus the line width of the light source used or the maximum extent of the mutual coherence in order to obtain the required coherence parameters having the lowest coherence properties.

The reducing of the coherence of the light used is a basic requirement to provide high image contrast and the intended retinal image without disturbing effect in other words, it is important to reduce the coherence of the light in such a way that reasonable high coherence as required is provided in order to prevent unintentional coherent crosstalk. Further, the complex-valued point spread functions of the entire system, which includes the illumination unit, the SLM and the retina of the eye of an observer, i.e. the complete display device in connection with the eye of the observer, has to be optimized too.

In the following the present invention Is described for two-dimensional (2D) encoded holograms in an SLM, which in detail use procedures for reduction of the retinal inter object point crosstalk:

The relation to a two-dimensional (2D) encoding of holograms has several aspects. The general requirements of optimizing the point spread functions in relation to the final design intensity distribution or to the target intensity distribution of the perfect image detected by the retina of the eye of an observer is already described and explained above to the one-dimensional encoded holograms.

The generation of independent and mutual incoherent subsets of the three-dimensional (3D) object representing wave fields, which is already described for one-dimensional (1D) encoded holograms, can also be applied to two-dimensional (2D) encoded holograms. In other words, a separator designed as a color filter arrangement can also be applied to two-dimensional encoded holograms. The color filter arrangement has to be adapted to the SLM used, in which the holograms are encoded in two coherent directions. For example, it can be used a Bayer color filter array or Bayer pattern as color filter arrangement.

For reducing of crosstalk between adjacent point spread functions on the retina of the eye of an observer, for example, it can be used a standard pixel aperture of a pixel of the SLM, which is e.g. 33 μm×33 μm for a two-dimensional encoded three-dimensional holographic display device used at a viewing distance of 600 mm. For the sake of simplicity, a rectangular shaped pixel aperture of a pixel can be assumed. Furthermore, apodization profiles can be applied, as e.g. a Gauss-type amplitude apodization or a so-called Kaiser-Bessel-Window.

By way of example, it is assumed to use an SLM having rectangular shaped apertures of pixels. This is illustrated in FIG. 6, where 10×10 pixels are shown. The fill factor FF of the SLM is approximately FF=0.9, which is an idealized value. Such a fill factor might only be realized e.g. by a reflective-type SLM as e.g. LCoS (liquid crystal on silicon) but not by transmissive-type SLM with a pixel pitch of 33 μm.

FIG. 7 shows the intensity distribution of the Fourier transformation of the intensity distribution shown in FIG. 6 representing the amplitude distribution of an SLM plane. The central spot is equivalent to the 0^{th} diffraction order of a diffraction pattern of the SLM within the plane of its Fourier transformation, which is the plane of the viewing window or the observer plane. Due to the very high fill factor of FF=0.9 assumed for the SLM, there are probably no visible higher diffraction orders than the central zero diffraction order spot. For this calculation a constant phase of the SLM is assumed. In other words, phase change introduced by the encoding will definitely lead to significantly increased intensity values of the higher diffraction orders, which are present within the plane of the eye of the observer. A fill factor of FF=1 will not eliminate completely the intensity in the higher diffraction orders, i.e. an intensity of diffraction orders with a diffraction order index m larger than 0 or in two directions with mₓ and m_{y}>1. The higher diffraction orders will be present if no constant phase distributions are written into the SLM. But in general, although the values of the higher diffraction order peaks will be changed with the encoded content displayed on the SLM, a higher fill factor will cause less intensity in the higher diffraction orders than a smaller fill factor. However, it is assumed a constant phase for the generic layout of the SLM described herein.

As disclosed above, it is assumed an SLM having rectangular shaped apertures of the pixels. However, the pixels are for example now non-quadratic and have a ratio of the width to the height of 1 to 2. Such an SLM is shown in FIG. 8, where 10×10 pixels are illustrated. The fill factor FF of the SLM is approximately FF=0.5, i.e. it can also be a little bit smaller than 0.5, e.g. 0.45 only. But in order to keep said embodiment simple and comprehensible, it can be assumed a fill factor of 0.5 here. The pixel pitch is e.g. 33 μm in both directions, i.e. horizontal and vertical. The height of a pixel of the SLM is close to 33 μm while the width of said pixel is close to 16 μm only. Only the left half of the pixel apertures of the SLM is used in this embodiment.

FIG. 9 shows the intensity distribution of the Fourier transformation of the intensity distribution shown in FIG. 8 in the plane of the eye of an observer. The central peak is the intensity of the 0^{th} diffraction order. The larger fill factor of the SLM in the y-direction, i.e. in the horizontal direction, leads to reduced side lobes along the y-direction in the plane of the eye of the observers, which is the plane of the viewing window or the observer plane. Thus, it is preferred to use the larger fill factor along the horizontal direction of the SLM. The intensity distribution shown in FIG. 8 is equivalent to the intensity distribution of the viewing window plane in the case of encoding an empty hologram, i.e. to use a constant phase value in the SLM plane and the same amplitude for all pixels of the SLM. Compared to FIG. 6 and its Fourier transformation shown in FIG. 7 the decreased horizontal width of the pixels leads to increased ±1^{st} horizontal diffraction orders of the SLM in its Fourier transformation plane, which is the plane of the viewing window within which the eye of the observer is provided. For this embodiment shown in FIGS. 8 and 9, the horizontal diffraction orders larger than m=±3 show intensities which are small enough so that they will not disturb the viewing experience in the neighboured eye. Here, no significant horizontal ±4^{th} diffraction orders exist.

By way of example, if it is assumed a wavelength for the blue primary color of λ=450 nm, a focal length of the volume grating based field lens used within a desktop-type holographic three-dimensional (3D) display device of f=600 mm and a pixel pitch of 33 μm, a viewing window in an observer plane formed by the blue light has then an extension of approximately 8 mm times 8 mm. The 3^{rd} diffraction order is provided at approximately 24 mm from the zero diffraction order spot. For a wavelength of λ=650 nm, being assumed for the read primary color, the 3^{rd} diffraction order is provided at approximately 35 mm from the zero diffraction order spot. This means that for an average distance of the two eyes of an observer of 65 mm, a distance of 35 mm is sufficient.

FIG. 10 shows a binary amplitude transmission of an SLM having rectangular shaped apertures of the pixels and a fill factor of approximately 0.5. Here, 10×10 pixels are shown again. The embodiment shown in FIG. 10 is the equivalent of only using the left half of the pixel apertures, which is shown in FIG. 6, or using the areas not used in the distribution shown in FIG. 8. That is to say, according to FIG. 10 only the left half of the pixel apertures is used. Of importance is here the fact that the initial situation of the pixels shown in FIG. 6 is used and two subsets out of this initial SLM are generated. A right subset is shown by the SLM of FIG. 8 and a left subset is shown by the SLM of FIG. 10.

The right subset of the initial SLM shown in FIG. 6, which is illustrated in FIG. 8, and the left subset of the initial SLM, which is illustrated by the SLM shown in FIG. 10, generate equivalent intensity distributions in the Fourier plane of the SLM. In other words, the intensity distribution of the Fourier plane of the amplitude distribution shown in FIG. 8 and the amplitude distribution shown in FIG. 10 are the same and will be as shown in FIG. 9, if a constant phase is used in the SLM. At this point it is not of relevance that the phase of both Fourier transformations is different. This has only to be considered if the two subsets of the SLM of FIGS. 7 and 9 are superimposed coherently. However according to the invention, it is used an incoherent superposition of the two subsets of the SLM shown in the FIGS. 7 and 9 as amplitude distributions.

Different types of subsets of the SLM can be used in order to generate incoherent subsets of wave fields representing the three-dimensional (3D) holographic object to be displayed to the observer. For generating of incoherent subsets of wave fields a separator can be used. As separator a color filter stripes arrangement providing spatial separated colors, an arrangement of patterned retarders providing spatial separated orthogonal polarization states or a light source arrangement in the illumination unit providing spatial separated allocation of the wave field illuminating the SLM can be used.

The physical 50% addressing of the SLM is used. For the sake of simplicity and for a simple explanation of the present invention it is concentrated on simple embodiments of the present invention only. Simple embodiments mean to use only the simple subsets of an SLM, i.e. e.g. to use the two simple subsets of the SLM shown in FIG. 6, which are shown in the FIGS. 8 and 10.

If the fill factor FF is much smaller than shown in FIG. 10, it is preferred to subdivide a primary square shaped pixel of e.g. 33 μm×33 μm into two subsets, which are obtained by using an upper and a lower part of the pixel instead of using the right and the left part of the pixel. Thus, it might be preferred to implement a ratio of the width to the height of the pixel of 2 to 1. Higher diffraction orders of the SLM will then be dominant along the vertical direction and not along the horizontal direction, which reduces potential crosstalk between the content displayed to the left eye and the right eye of the observer. The probability of using this embodiment is increased if the critical dimension, which is the smallest structural dimension of the implemented layout of the SLM, of the manufacturing process of the SLM is e.g. 5 μm only. A critical dimension of 3 μm will lead to a larger fill factor. Therefore, it is preferred to use a critical dimension of e.g. 5 μm only.

The following describes an embodiment of an SLM provided with a separator, which is designed as an arrangement of patterned retarders. An arrangement of patterned retarders is used for transforming light incident on the SLM and having an initial polarization state, which might be e.g. a linear polarization state, into two patterned subsets of the light. The two patterned subsets of the light have an orthogonal polarization state. For example, the primary e.g. quadratic/square shaped pixel aperture, as can be seen e.g. FIG. 6, is divided into two parts. This means that the initial pixel count and, therefore, also the initial pixel density is doubled. The two pixel subsets of all pixels of the SLM, as can be seen e.g. in FIGS. 8 and 10, are provided with an arrangement of patterned retarders. A first subset of a pixel is provided with e.g. a +π/4 patterned retarder and a second subset of the pixel is provided with e.g. a −π/4 patterned retarder. If the SLM comprising these two subsets of a pixel is illuminated with linear polarized light at the exit plane of the SLM two orthogonal polarized wave fields will then exist, which refer to the two SLM subsets carrying different patterned retarders.

In the following section it is described if one, two or several light sources per color are provided. If classic optics or in general non-polarization-selective optics would be used to form the plane of the viewing window, then the described embodiments in order to generate two spatial interlaced subsets of the wave field representing the three-dimensional object to be presented to the observer can be used. Adjacent object points imaged on the retina of an eye of an observer show orthogonal polarization states and interfere thus in the same way as mutual incoherent points or in more detail as retinal point spread functions. In other words, along one direction there is no coherence. Thus, there is no coherent retinal inter object point crosstalk between adjacent object points, which are adjacent point spread functions on the retina of the eye of the observer, along one direction.

However, if the optical elements following the SLM within the beam path are polarization selective or require only a single polarization state, a different way has to be used in order to implement two mutually incoherent wave fields. In this case a common exit polarization state has to be used. This means that no mutual incoherence would exist if a single primary light source is used.

Per primary color at least two mutually incoherent light sources should be used, which illuminate the SLM. The SLM comprises e.g. a separator designed as an arrangement of patterned retarders. The arrangement of patterned retarders is assigned to the pixels of the SLM. Preferably, the arrangement of patterned retarders is designed as an arrangement of patterned polarization filters assigned to the at least two defined parts of the pixels, especially to the two subsets of the pixel apertures of the SLM.

For example, it can be used a wedge-type illumination unit, which is optimized in order to accept two orthogonally polarized wave fields. One wave field comes from a first light source of the illumination unit. This light can be e.g. TE (transverse electric) polarized. Another wave field comes from a second light source of the illumination unit. This light can be e.g. TM (transverse magnetic) polarized. Finally, the SLM is illuminated with both wave fields.

FIG. 11 illustrates the embodiment of a two-dimensional wire grid polarizer, which can be implemented as one of the two mirrors used at the ends of the resonator of a laser diode as light source. The pattern shown can be realized by generating two crossed highly reflective one-dimensional (1D) wire grid structures. The period of this special wire grid-type polarizer is smaller than π/2π, where π is the wavelength of the light source, e.g. the laser diodes, and n is the refractive index of the substrate/structure of the polarizer. Two linear orthogonal polarization states have a maximum reflectivity of close to 1. A metallic two-dimensional striped wire grid polarizer structure can be enhanced in its reflectivity by adding a dielectric layer stack. For example, the in FIG. 11 shown wire grid polarizer structure or different mirror versions can be used at the end of a light source cavity in order to provide e.g. two orthogonal linear exit polarization states out of the SLM. By adding e.g. a Bragg-type resonator mirror to the illumination unit wavelength stabilization can be implemented too. Thus, a line width of the light source of e.g. 0.1 nm can be combined with a stable wavelength, which shifts e.g. about less than 0.1 nm during operation of the display device. This structure can be further combined or can be further developed to obtain two orthogonal polarized exit beams out of the SLM, which are mutually incoherent. This means it can be realized a cost-efficient single light source, e.g. a laser diode-type light source, which can be used in the display device according to the present invention.

For other applications e.g. three or more mutually incoherent exit beams out of an SLM can be generated. These exit beams are linear polarized.

In FIG. 12 a binary amplitude transmission of an SLM is shown. The SLM comprises rectangular shaped pixel apertures and a fill factor of approximately FF=0.5. Here, 10×10 pixels are shown again, as example. The fill factor is the same as the fill factor of the SLM shown in FIG. 8. A separator designed as an arrangement of patterned retarders, preferably a patterned polarization filter, is assigned to the pixel of the SLM, particularly to the apertures of the pixel of the SLM. The patterned polarization filter allows the transmission of a horizontal orientated electrical field. Here, only one patterned polarization filter is required, which can be assigned to all pixels of the SLM.

FIG. 13 shows a binary amplitude transmission of an SLM having rectangular shaped pixel apertures and a fill factor of approximately FF=0.5. Here, 10×10 pixels are shown again, as example. The fill factor is the same as the fill factor of the SLM shown in FIG. 10. A separator designed as an arrangement of patterned retarders, preferably a patterned polarization filter, is assigned to the pixel of the SLM, particularly to the apertures of the pixel of the SLM. The patterned polarization filter allows the transmission of a vertical orientated electrical field. Here, only one patterned polarization filter is required, which can be assigned to all pixels of the SLM.

A nested arrangement of two subsets of a pixel of an SLM is shown in FIG. 14. Two adjacent subsets in a row of the SLM each generate orthogonal exit polarizations of the light out of the SLM. This means that two adjacent columns of the SLM generate orthogonal exit polarizations of the light out of the SLM. This embodiment shown in FIG. 14 is a combination of the embodiments shown in the FIGS. 12 and 13. Only one patterned polarization filter according to the patterned filter shown in FIGS. 12 and 13 cannot be used for this embodiment of the SLM. Therefore, a patterned polarization filter has to be used that comprises nested polarization segments assigned to the individual pixels or individual columns of the SLM. Or, it has to be used two patterned polarization filters that are arranged to each other in such a way that two adjacent subsets of a pixel generate orthogonal exit polarization of the light out of the SLM.

The adding of a further single polarizing filter behind the SLM, seen in the propagation direction of the light, provides a single light exit polarization state, which contains two mutually incoherent wave fields both carrying a part of the three-dimensional object scene.

This wave field can now propagate through all optical elements of the display device, which follow within the beam path regardless of the polarization selectivity of these elements. For example, a polarization-type LC grating following the SLM in the beam path has to be illuminated with circular polarized light; a retarder has then to be used for providing the required polarization state of the wave field illuminating it.

Also, in two-dimensional (2D) encoding of holograms an arrangement of color filter stripes can be used in the SLM plane. For this it might be more complex since an initial pixel aperture of the pixel of the SLM, which can be e.g. 33 μm times 33 μm for a holographic three-dimensional desktop display device, has to be divided into at least three sub-pixels or three subsets or generally into three defined parts of the pixel. FIG. 15 shows a binary amplitude transmission of an SLM having rectangular shaped pixel apertures and a fill factor of approximately FF=0.25 only. Here, 10×10 pixels are shown again, as example. This is equivalent to using the lower right quarter of the pixel apertures shown in FIG. 6, i.e. ¼ of the maximum aperture only. As a matter of course, it can also be used different defined parts of the pixel, for example the upper left quarter of the pixel.

FIG. 16 shows an intensity distribution of the Fourier transformation of the intensity distribution shown in FIG. 15. This intensity distribution is generated in the plane of an eye of an observer. The central peak in the illustration shows the intensity of the 0^{th} diffraction order. The small fill factor of FF=0.25 of the SLM increases the intensity of the higher diffraction orders. It can be seen that it is possible to implement e.g. three sub-pixels within the e.g. Initial 33 μm times 33 μm pixel size while keeping the higher diffraction orders, which exist within the plane of the viewing window in the observer plane, within an acceptable limit.

A sub-pixel or a subset of the pixel comprising a color filter segment of the arrangement of color filter stripes relating to one of the primary colors RGB has an extension of e.g. 16 μm times 16 μm only. It is probably expensive to realize pixels as small as this. However, it could be possible in a few years without high technical effort. In addition, a small critical dimension is required within the manufacturing of the pixels in order to keep the fill factor as high as possible. Thus, e.g. a critical dimension of 3 μm might be required in order to realize color filters within a two-dimensional encoded complex-valued SLM.

Furthermore, an arrangement of two-dimensional color filter stripes might be combined advantageously with an arrangement of patterned retarders designed e.g. as orthogonal polarization filters. However, this could reduce the practical critical dimension in the manufacturing of the SLM e.g. down to 2 μm only. The initial pixel size of e.g. 33 μm×33 μm has to be divided e.g. into 6 defined part or subsets of the pixel or sub-pixels. This means three colors in relation to the color filter stripes and two additional patterned polarization filters. Each polarization filter is assigned to a triplet of color filter stripes. Thus, each primary color RGB is represented by two small subset of the pixel. The two subsets of the pixel emit orthogonally polarized light.

For example, each pixel aperture shown in FIG. 14 can be sub-divided into e.g. three color subsets of the pixel. This requires, however, a significant technological effort and might therefore not be the fastest way to an initial product.

In addition to rectangular arrangements of the apertures of the pixels of an SLM also e.g. hexagonal arrangements of the apertures of the pixels may be used. These arrangements can also be provided with an arrangement of patterned retarders, preferably patterned polarization filters, and/or an arrangement of patterned color filter stripes.

The probably more practical realization of two orthogonal polarizations of the light emitted by the SLM could be in general to encode a wedge function into the sub-hologram of the SLM. In this manner object points within the angular range spanned by the viewing window can be shifted laterally. For a two-dimensional encoding of a hologram this can be done along the vertical direction as well as for the horizontal direction. In other words, a left separation and a right separation of a quadratic/square area of a pixel, as can be seen e.g. in FIG. 14, can generate a horizontal separation, which is a left separation and a right separation of adjacent orthogonally polarized retinal point spread functions. An upper separation and a lower separation of a square area of a pixel can generate a vertical separation, which is an upper separation and a lower separation of adjacent orthogonally polarized retinal point spread functions. This also applies if the initial quadratic area of the pixel shape within the SLM plane is divided into an upper rectangular and a lower rectangular part or subset. Such an SLM would be if the SLM shown in FIG. 14 would be rotated about 90 degrees clockwise or counterclockwise. This is shown in FIG. 17, in which an arrangement of polarization filters in an SLM plane is illustrated, where the arrangement of polarization filters is arranged orthogonal to the one of FIG. 14.

Recapitulating, according to the present invention there are for example two or even more subsets of wave fields generated by an SLM of the display device, which are mutually incoherent. In the case of a one-dimensional encoding an arrangement of color filter stripes, an arrangement of patterned retarders, particularly an arrangement of polarization filters having orthogonal polarization, or combinations thereof can be used in order to provide mutually incoherent subsets of wave field partially representing a three-dimensional object or scene. As for the case of two-dimensional encoding in one-dimensional encoding it is also possible to illuminate an SLM with light that has two orthogonal states of polarization and that is emitted from different light sources in the illumination unit. This light can illuminate a striped pattern of a polarization filter, which has an alternating orientation of the polarization state transmitted. Also, as for the case of two-dimensional encoding the polarization filter is followed by an additional non-patterned retarder, particularly a polarization filter, which transmits a single polarization state only. It could be that light gets lost here. But there are two mutual incoherent encoded wave fields now, which illuminate the optical elements following the SLM in the beam path of the display device. It can also be encoded an additional phase wedge in a sub-hologram along one direction. In contrast to the case of one-dimensional encoding, the two-dimensional encoding offers the realization of arbitrary shaped two-dimensional phase wedge functions encoded in the sub-holograms of the SLM. Only one subset of the potential two-dimensional wedge distributions is needed for that.

An advantageous polarization encoding pattern of adjacent object points is given by a checkerboard-like distribution, which is applied for the object points reconstructed. Furthermore, a honey comb-like distribution may also be used, which also provides two orthogonal polarizations. This is provided in the plane of the object points or in the plane of the retina of an eye of an observer in the case the observer focuses on the object point. Furthermore, it is also possible to use other e.g. random distributions of the mutual incoherent pattern.

In FIG. 18 an illustration of a checkerboard-like allocation pattern of orthogonal polarization states is shown, which refers to three-dimensional object points reconstructed in space or on the retina of an eye of an observer in the case the observer focuses on these object points. Object points can be generated at different grids in space. In FIG. 18 the polarization state of 98 pixel times 98 pixels reconstructed in space can be seen. This is e.g. only one plane of the object. In the three-dimensional space adjacent depth planes can comprise alternating allocation pattern. This means that object points having the same x-coordinate (horizontal direction) and y-coordinate (vertical direction) but are placed at adjacent depth planes can preferably have orthogonal polarization states. In other words, the polarization state allocation pattern shown in FIG. 18 can be used along the z-direction (depth direction, i.e. parallel to the optical axis of the display device) in an alternating way, i.e. the polarization states are inverted for adjacent z-planes.

This simple grid of FIG. 18 may also be changed to a hexagonal honeycomb-type grid. It is also possible to arbitrary change the initial pattern related to the content of the scene. However, this will probably further increase the complexity of the optimization of the encoding process. Furthermore, the polarization state allocation pattern may be changed in two dimensions (x and y direction) as well as along the z-coordinate. The simplest approach, however, could be to use a fixed pattern along the vertical direction (y-direction) and the horizontal direction (x-direction) and invert it in an alternating way along the depth direction (z-direction), which is the distance to the observer or the distance of the different z-planes to each other.

The following explanations refer to the calculation of point spread functions PSFᵢⱼ for retinal inter object point crosstalk reduction relating to head-mounted displays. However, as it can be seen before, the retinal point spread function optimization can be used for all types of sub-hologram based holographic display devices, for one-dimensional encoding and two-dimensional encoding too. Consequently, the invention can also be used for direct view display devices, e.g. for desktop display devices using two-dimensional encoding of television display devices using one-dimensional vertical parallax only encoded holograms.

The most simple case is one-dimensional encoded vertical parallax only (VPO) holography, which uses vertical orientated sub-holograms. If an light source of an illumination unit is adapted in order to provide optimized absolute value of the complex degree of coherence, i.e. it is not a simple point light source, it can be ensured that only the pixels of one vertical line that have a mutual distance of equal or less than the size of the largest sub-hologram are mutually coherent.

Assume one-dimensional vertical parallax-only encoding and tailored illumination of the illumination unit the optimization of adjacent point spread functions can be carried out along one direction and for each column of the SLM separately. Furthermore, only close neighbors of the discrete point spread function to be optimized have to be considered.

For example, taken a sub-hologram of the upper left corner of the SLM each color can be provided separately, and the retinal point spread functions PSFᵢⱼ can be calculated then. The index i may be used to mark the column of the SLM and the index j can be used to mark the row of the SLM used in the calculation process. These are indices of a retinal grid of object points generated in space. These indices may also be used to indicate the discrete sub-holograms relating to the retinal object points. A defined diameter of the entrance pupil of the human eye can be assumed in relation to the brightness of the scene, which is e.g. 2.9 mm for 100 cd/m². It could be that all non-optimized sub-holograms are already generated or that they will be just generated after each other. For example, it is assumed that all non-optimized sub-holograms were already generated. Then a first point spread function PSF₁₁ is calculated.

The computational load of the optimization process can be concentrated on the high definition (HD) cone. This means a high definition 1/60 degrees resolution can only be seen in a central cone, e.g. at an angle of approximately 10 degrees. During the optimization it can be concentrated primarily on that central cone. Thus, more power in the high definition (HD) cone can be used as for other areas, e.g. at the edge of the retina. For a single observer in the observer plane one high definition cone per eye and color is provided. The number of cones depends on the number of observers. Gaze tracking is required to provide the high definition cone accurately. This means that it is preferred to integrate gaze tracking in the display device.

Moreover, thinned objects in the non-high definition cone area can be used. For example, at the rim of the field of view, 4×4 thinning can be used for a two-dimensional encoding, as long as the object points are reconstructed with 16 time larger brightness. This is not a problem because the optical energy per area is kept constant. For a two-dimensional encoding it may be used every fourth object point only along the vertical direction and along the horizontal direction. For vertical parallax-only encoded holograms a four times thinning can only be carried out along the columns of the SLM.

It can also be possible to project one high definition cone per eye and color into a low resolution frustum. This might be a combination of a direct view display device and a projection display device. Or it can be a combination of a large low resolution frustum generating display device and a high definition cone generating display device, which is defined by the gaze tracking data. However, this could add possibly significant technological effort.

Coming back to a second sub-hologram of the vertical parallax-only encoded hologram example, which generates a point spread function PSF₁₂ on the retina of an eye of an observer. Now, e.g. only the second sub-hologram is changed, i.e. the phase offset to the point spread function PSF₁₁ and the intensity value of the point spread function PSF₁₂ are changed in order to obtain the target intensity of the point spread function PSF₁₁ plus the point spread function PSF₁₂, which is the design intensity. That is to say e.g. it is used a phase offset and an intensity change. Then, a point spread function PSF₁₃ is placed adjacent to the two coherently added point spread functions PSF₁₁ and PSF₁₂. Now, it is used once again e.g. a phase offset and an intensity change to change the initial point spread function PSF₁₃ in order to obtain the design intensity distribution of the coherent sum of the point spread functions PSF₁₁+PSF₁₂+PSF₁₃. This can be demonstrated by the way from j to j+1 to j+2 . . . j+N, i.e. to the last point spread function PSFᵢⱼ formed by the discrete column of the SLM, here column 1. Then, the next column of the SLM is carried out. For vertical parallax-only encoded holograms the optimization process made along the columns of the SLM can be carried out in parallel. This is due to the fact that the columns of the SLM are mutually incoherent if using the tailored illumination. To make and keep the calculation and optimization algorithm fast and simple the peak intensity value of the point spread function provided locally on the retina can be used as criterion for the optimization process. It could still make sense to e.g. use the integral intensity value of an angular range of 1/60 degrees instead the single peak intensity value. The difference is, however, small. Using e.g. three or more sampling points of a single point spread function for the optimization may add more effort, i.e. more computational load.

For a two-dimensional encoding of holograms the optimization can be carried out in an analogue way to the one-dimensional encoding of holograms. It may be started e.g. in the upper left corner of the sub-holograms or the retinal point spread functions PSFᵢⱼ of the object points. A first point spread function PSF₁₁ is formed and a second point spread function PSF₁₂ is added. This summed up point spread function is optimized by using a phase offset and a change of the intensity if required. Then, e.g. a point spread function PSF₂₁ is added and optimized using phase and intensity too. Now, a point spread function PSF₂₂ is added and the phase offset and the intensity value on demand are changed. Then, e.g. a point spread function PSF₁₃ is added and the phase offset and the intensity value are optimized. Next indices of the point spread function PSFᵢⱼ may be e.g. 23 and 31, followed e.g. by 14 and so on. This means, for example, it can be started from the upper left corner of the sub-hologram and to fill and optimize the scene step by step until the lower right corner is reached.

Different paths for this optimization process may be used. For example, it can be started with a point spread function PSF₁₁ and then go to point spread functions PSF₁₂, PSF₁₃, PSF₁₄, . . . to PSF_{1N}, where N is the number of vertical object points to be generated, e.g. 1000 object points or even 2000 object points. The number of the object points being generated horizontally in M might be e.g. 2000 to 4000. In detail, this could mean that at first the first column of the sub-hologram is filled and completed and then step by step the elements of the second column are added, i.e. point spread function PSF₂₁, PSF₂₂, PSF₂₃, PSF₂₄, . . . to PSF_{2N}. Here, the step by step filling and optimizing is carried out from the left hand side to the right hand side of the sub-hologram. In this manner a two-dimensional matrix in M,N can be created.

This optimization continuing along a predefinable direction on the SLM can also be carried out in a parallel way, e.g. if a multi-core integrated circuit is used. Thus, the starting points in the sub-hologram can be chosen in an arbitrary way or at least several starting points can be chosen. If locally optimized zones (zones that are filled during the optimization) of the sub-hologram hit each other, then the transition zones can be optimized. This can already be done if the mutual gap is e.g. five point spread functions PSFᵢⱼ only. This means that a point spread function may be added to the rim of one zone and the small part of the rim of the neighboring zone can already be considered during the filling of the gap, which exists between two adjacent zones.

Randomized local optimization using multiple randomized starting points may be used to avoid the appearance of artificial and disturbing low spatial frequency modulations. The optimization process can be made simple by only using a phase offset and intensity offset of single point spread functions PSFᵢⱼ.

For increasing the calculation speed, which might be required for real time applications, a look-up-table (LUT) can be used for image segments that can already be optimized in advance, as e.g. lines, surfaces, triangles and small separated objects.

If gaze tracking data are already used, e.g. in order to use the 10 degrees high definition cone approach in e.g. direct view displays, and if the eye tracking data are used to obtain the diameter of an entrance pupil of an eye of an observer, the point spread functions of the eye picking up the object points in space can be monitored. This means that point spread function data can be used that are closer to the real situation. Thus, better optimization results can be obtained. A look-up-table can also be used to represent different point spread functions of the human eye, i.e. different diameter of the entrance pupil of the eye and different focal length f_{eye}.

The optimization process described for a head-mounted display can be used, of course, for other display devices, as e.g. direct view display devices, projection display devices.

Finally, it must be stated explicitly that the embodiments to the display device described according to the invention shall solely be understood to illustrate the claimed teaching, but that the claimed teaching is not limited to these embodiments. Combinations of embodiments are also possible.

1. A display device for holographic reconstruction of two-dimensional and/or three-dimensional objects including a plurality of object points, comprising:
an illumination unit emitting sufficiently coherent light
a spatial light modulator device, in which sub-holograms of object points to be displayed are encoded in pixels
a separator for separating adjacent point spread functions in an eye of an observer generated by the sub-holograms of adjacent object points such that the adjacent point spread functions are mutual incoherent to each other.

2. The display device according to claim 1, wherein the object is divided into at least two object planes, where each object plane is divided into at least two vertical subsets and at least two horizontal subsets, which are angularly displaced or shifted relative to each other.

3. The display device according to claim 1, wherein for one-dimensional encoded holograms or for two-dimensional encoded holograms in the spatial light modulator device, the separator is designed as a color filter stripes arrangement, preferably a primary color filter stripes arrangement.

4. The display device according to claim 1, wherein each initial pixel of the spatial light modulator device is subdivided into at least two defined parts representing at least two subsets and generating at least two wave fields.

5. The display device according to claim 4, wherein a triplet of color filter stripes is assigned to each subset.

6. The display device according to claim 3, wherein the color filter stripes arrangement is an absorptive-type dye based filter arrangement or a dielectric filter arrangement, which is structured assigned to the subset.

7. The display device according to claim 4, wherein for a two-dimensional hologram to be encoded, the at least two defined parts of the initial pixel form two halves, where the pixel is separated horizontally or vertically.

8. The display device according to claim 1, wherein the separator is designed as an arrangement of patterned retarders.

9. The display device according to claim 8, wherein the arrangement of patterned retarders is provided for transforming light having a defined polarization state into two patterned light subsets.

10. The display device according to claim 8, wherein the arrangement of patterned retarders is provided in a plane of the pixels and assigned to the pixels of the spatial light modulator device, where each defined part of the initial pixel is provided with a defined patterned retarder of the arrangement of patterned retarders.

11. The display device according to claim 10, wherein the at least two defined parts of the initial pixel have different patterned retarders providing orthogonal polarization.

12. The display device according to claim 8, wherein the polarization orientations of adjacent patterned retarders, seen only in the horizontal direction or only in the vertical direction, are orthogonal to each other.

13. The display device according to claim 8, wherein the arrangement of patterned retarders is designed as an arrangement of patterned polarization filters assigned to the at least two defined parts of the initial pixels.

14. The display device according to claim 13, wherein the arrangement of patterned polarization filters provides a striped pattern, which has an alternating orientation of the polarization state transmitted.

15. The display device according to claim 13, wherein the arrangement of patterned polarization filters provides a pattern of orthogonal polarization states, which is a fixed pattern along the vertical direction (y direction) and the horizontal direction (x direction), where along the depth direction (z direction) the pattern is inverted and is used in an alternating way.

16. The display device according to claim 1, further comprising a non-patterned retarder arranged behind the spatial light modulator device, seen in the propagation direction of light, for providing light having a single exit polarization state containing two mutually incoherent wave fields.

17. The display device according to claim 1, wherein in the calculation of the sub-hologram representing the object point a wedge function is used for laterally shifting the object points within a defined angular range.

18. The display device according to claim 17, wherein the wedge function is an arbitrary shaped two-dimensional phase wedge function.

19. Display device according to claim 1, wherein the relative phase of complex values of wavefronts for the individual object points is defined in such a way that the difference between the total intensity distribution in the eye of the observer generated by the point spread functions representing adjacent object points of the object and the target intensity distribution is minimized.

20. The display device according to claim 1, wherein the amplitude of complex values of wavefronts for the individual object points is defined in such a way that the difference between the total intensity distribution in the eye of the observer generated by the point spread functions representing adjacent object points of the object and the target intensity distribution is minimized.

21. The device according to claim 1, wherein an apodization profile is provided in the plane of the pixels of the spatial light modulator device to achieve apodized sub-holograms of the individual object points of an object.

22. The display device according to claim 1, wherein the sub-holograms are modifiable in their shapes.

23. The display device according to claim 1, wherein a fixed predefined grid of object point spread functions provided in the eye of the observer is used.

24. The display device according to claim 1, wherein the illumination unit is adapted in such a way to emit two orthogonally polarized wave fields, preferably by using a wire grid polarizer structure.

25. The display device according to claim 1, wherein the illumination unit comprises at least one light source, preferably a laser or a laser diode, provided to generate a wave field.

26. The display device according to claim 1, wherein the illumination unit comprises at least one light source per primary color.

27. The display device according to claim 1, wherein the illumination unit comprises a stripe-like light source arrangement.

28. The display device according to claim 1, wherein per primary color at least two mutually incoherent light sources are provided.

29. The display device according to claim 1, wherein the spatial light modulator device is illuminated with an angular spectrum of plane waves of < 1/60° degrees along the coherent direction and 0.5° to 1° degrees along the incoherent direction.

30. The display device according to claim 1, wherein the mutual coherence field is limited to a maximum extension, the maximum extension is the size of the largest sub-hologram in the spatial light modulator device.

31. The display device according to claim 1, wherein the spatial light modulator device is designed as a complex-valued spatial light modulator device, which is able to reconstruct different incoherent object point subsets relating to different primary colors.

32. A method for optimization of the image quality of reconstructed two-dimensional and/or three-dimensional objects, where each object includes a plurality of object points, where for each object point a sub-hologram is calculated which is encoded in pixels of a spatial light modulator device, where reconstructed adjacent object points generate adjacent point spread functions in an eye of an observer, the point spread functions are separated by a separator such that the adjacent point spread functions superpose merely incoherently in the eye of the observer.

33. The method according to claim 32, wherein incoherent subsets of wave fields representing the object point to be displayed to the observer are generated and superposed incoherently.
